(19) United States
(12) Patent Application Publication
(10) Pub. No.: US 2026/0023683 A1
(43) Pub. Date: Jan. 22, 2026

(54) IN-MEMORY PROCESSOR AND MEMORY DEVICE INCLUDING THE IN-MEMORY PROCESSOR

(71) Applicant: Samsung Electronics Co., Ltd., Suwon-si (KR)

(72) Inventors: Shinhaeng Kang, Suwon-si (KR); Suk Han Lee, Suwon-si (KR); Kyomin Sohn, Suwon-si (KR)

(21) Appl. No.: 19/016,130

(22) Filed: Jan. 10, 2025

(30) Foreign Application Priority Data
Jul. 18, 2024 (KR) 10-2024-0095143

(51) Int. Cl. G06F 12/02

(52) U.S. Cl. CPC G06F 12/0223

(57) ABSTRACT

According to some embodiments of the present disclosure, an in-memory processor included in a memory device may be provided. The in-memory processor may include an instruction list circuit configured to store a first instruction including a first register indexing field, a calculation register array including a plurality of calculation registers, a processing management circuit configured to store a register indexing rule table and an address log that includes a first register indexing rule that corresponds to a value of the first register indexing field, and the processing management circuit is configured to identify a first calculation register of the plurality of calculation registers based on the first register indexing rule and the address log, and a calculation circuit configured to perform a first calculation operation for the first instruction based on the first calculation register.

### CROSS-REFERENCE TO RELATED APPLICATION

This application claims priority to and the benefit of Korean Patent Application No. 10-2024-0095143 filed in the Korean Intellectual Property Office on Jul. 18, 2024, the entire contents of which are incorporated herein by reference.

### BACKGROUND

The present disclosure relates to a semiconductor memory device. More particularly, the present disclosure relates to an in-memory processor configured to perform calculations and a memory device including the same.

In general, an operating speed of a memory system including a memory device and a host device may be bottlenecked by a communication speed between the memory device and the host device. As a result, various techniques for solving bottlenecks due to the communication speed are being studied. For example, recently, a processing-in-memory (PIM) technology has been studied, in which the memory device performs an in-memory processing operation.

The memory device may include an in-memory processor. The in-memory processor may perform predefined calculation operations in response to a request from the host device. However, due various reasons such as a width of a command/address signal channel formed between the host device and the memory device, the number of calculation operations which may be performed by the in-memory processor may be limited.

### SUMMARY

The present disclosure attempts to solve the technical problem described above. More specifically, the present disclosure attempts to provide an in-memory processor configured to perform a larger number of calculation operations, and a memory device including the same.

Some embodiments of the present disclosure provide an in-memory processor included in a memory device, which may include an instruction list circuit configured to store a first instruction including a first register indexing field, a calculation register array comprising a plurality of calculation registers, a processing management circuit configured to store a register indexing rule table and an address log, the register indexing rule table includes a first register indexing rule that corresponds to a value of the first register indexing field, and the processing management circuit is configured to identify a first calculation register of the plurality of calculation registers based on the first register indexing rule and the address log, and a calculation circuit configured to perform a first calculation operation for the first instruction based on the first calculation register.

Some embodiments of the present disclosure provide an in-memory processor included in a memory device, which may include an instruction list circuit configured to store a first instruction, a plurality of calculation registers, a processing management circuit configured to determine a first register index based on a first register indexing rule in response to reception of a first execution request for the first instruction at a first time point, and to determine a second register index based on a second register indexing rule in response to reception of a second execution request for the first instruction at a second time point after the first time point, and a calculation circuit configured to perform a first calculation operation for the first instruction based on a first calculation register corresponding to the first register index among the plurality of calculation registers, and to perform a second calculation operation for the first instruction based on a second calculation register corresponding to the second register index among the plurality of calculation registers.

Some embodiments of the present disclosure provide a memory device configured to perform a calculation operation, which may include an in-memory processor configured to perform the calculation operation based on a target calculation register of a plurality of calculation registers, and a control logic circuit configured to change a register indexing rule used to determine the target calculation register in response to a command provided from an external device.

### BRIEF DESCRIPTION OF THE DRAWINGS

FIG. 1 is a block diagram illustrating a memory system according to some embodiments of the present disclosure.

FIG. 2 is a block drawing more specifically illustrating the memory device of FIG. 1.

FIG. 3 is a block drawing more specifically illustrating the in-memory processor of FIG. 2.

FIG. 4 is a table more specifically illustrating a configuration of an instruction list circuit of FIG. 3.

FIG. 5 is a drawing more specifically illustrating a configuration of an instruction of FIG. 4.

FIG. 6 is a drawing more specifically illustrating a register indexing rule table of FIG. 3.

FIG. 7 is a drawing more specifically illustrating an operation of an in-memory processor according to some embodiments.

FIG. 8 is a timing diagram more specifically illustrating an operation of a memory device according to the embodiments of FIG. 7.

FIG. 9 is a drawing more specifically illustrating the operation of the in-memory processor according to some embodiments.

FIG. 10 is a timing diagram more specifically illustrating the operation of the memory device according to the embodiments of FIG. 9.

FIG. 11 is a flowchart illustrating the operation of the memory device according to some embodiments of the present disclosure.

FIG. 12 is a drawing more specifically illustrating step S1400 of FIG. 11.

FIG. 13 is a drawing more specifically illustrating step S1430 of FIG. 12.

FIG. 14 is a drawing more specifically illustrating step S1433 of FIG. 13.

FIG. 15 is a block diagram illustrating a memory system according to some embodiments.

FIG. 16 is a block diagram illustrating a configuration of a processing management circuit of FIG. 3 according to the embodiments of FIG. 15.

FIG. 17 is a drawing more specifically illustrating a method of changing an access key by a memory controller of FIG. 15.

FIG. 18 is a flowchart more specifically illustrating an operation of the memory controller of FIG. 15.

FIGS. 19 and 20 illustrate a method of storing a plurality of register indexing rules in the register indexing rule table of FIG. 3.

FIG. 21 is a block diagram illustrating a memory system according to some embodiments.

FIG. 22 is a command truth table illustrating a configuration of a processing command implemented according to some embodiments.

### DETAILED DESCRIPTION OF THE EMBODIMENTS

Hereinafter, embodiments of the present disclosure will be clearly and specifically described so that those skilled in the art of the present disclosure can easily implement the present disclosure. Details, such as detailed configurations and structures, are simply provided to help the overall understanding of the embodiments of the present disclosure. Therefore, the transformations of the embodiments described in the text can be performed by those skilled in the art without departing from the technical spirit and the scope of the present disclosure. Moreover, descriptions of well-known functions and structures are omitted for clarity and simplicity. The compositions in the following drawings or detailed description may be shown in the drawings or are connected to those other than the components described in the detailed description. The terms used in the text are the terms defined in consideration of the functions of the present disclosure and are not limited to specific functions. The definition of the terms may be determined based on the details described in the detailed description.

Components described with reference to the terms such as a driver or a block used in the detailed description may be implemented in the form of software, hardware, or combinations thereof. For example, software may be machine code, firmware, embedded code, and/or application software. For example, hardware may include an electrical circuit, an electronic circuit, a processor, a computer, integrated circuit cores, a pressure sensor, an inertia sensor, a micro electro mechanical system (MEMS), a passive element, or a combination thereof.

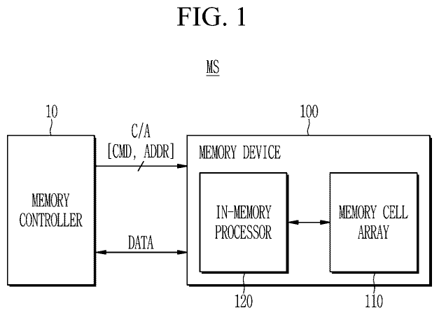

FIG. 1 is a block diagram illustrating a memory system according to some embodiments of the present disclosure. Referring to FIG. 1, the memory system MS may include a memory controller 10 and a memory device 100. The memory device 100 may include a memory cell array 110 and an in-memory processor 120.

In some embodiments, the memory system MS may be included in various types of electronic devices including a smartphone, a laptop, a personal computer, a tablet PC, etc.

In some embodiments, the memory controller 10 may be included in one of various types of processors including central processing unit (CPU), a graphic processing unit (GPU), etc.

Hereinafter, for brief description, it is assumed that the memory device 100 is a dynamic random access memory (DRAM) device, and the memory controller 10 and the memory device 100 communicate with each other based on a low power double data rate (LPDDR) interface. However, the scope of the present disclosure is not limited thereto. For example, the memory controller 10 and the memory device 100 may communicate with each other based on a double data rate (DDR) interface.

The memory controller 10 transmits a command CMD and/or an address ADDR to the memory device 100 to control an operation of the memory device 100. For example, the memory controller 10 may provide the command CMD and the address ADDR to the memory device 100 based on a plurality of command/address signals C/A.

The memory device 100 may operate in response to the control by the memory controller 10. For example, the memory device 100 may store data in the memory cell array 110, or provide the data stored in the memory cell array 110 to the memory controller 10 in response to the command CMD and the address ADDR.

The memory device 100 may perform various calculation operations in response to the control by the memory controller 10. For example, the in-memory processor 120 may perform various calculation operations based on a processing command (hereinafter, referred to as “PROC”) provided from the memory controller 10.

In some embodiments, the in-memory processor 120 may perform a calculation operation based on one or more operands. For example, the in-memory processor 120 may perform various calculations including add, multiplication, multiplication and accumulation (MAC), etc. In this case, although the memory controller 10 does not read one or more operands from the memory device 100, the memory controller 10 may be able to receive a calculation result based on the one or more operands from the memory device. Accordingly, according to embodiments of the present disclosure, a bottleneck phenomenon for an operation of the memory system MS which occurs due to communication between the memory controller 10 and the memory device 100 may be minimized.

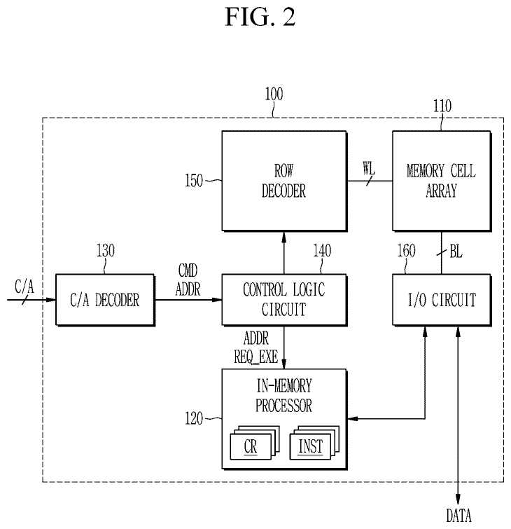

FIG. 2 is a block drawing more specifically illustrating a memory device of FIG. 1. Referring to FIG. 2, the memory device 100 may include the memory cell array 110, the in-memory processor 120, a command/address decoder 130, a control logic circuit 140, a row decoder 150, and an input/output circuit 160.

The memory cell array 110 may include a plurality of memory cells arranged in a row direction and a column direction. The plurality of memory cells may be connected to a plurality of word lines WL extending in the row direction and a plurality of bit lines BL extending in the column direction.

The command/address decoder 130 may receive the command/address signals C/A provided from the memory controller 10. The command/address decoder 130 may decode the plurality of command/address signals C/A to the command CMD and the address ADDR.

The control logic circuit 140 may receive the command CMD and the address ADDR from the command/address decoder 130. The control logic circuit 140 may control overall operations of the memory device 100 based on the command CMD and address ADDR. For example, the control logic circuit 140 may control operations of the in-memory processor 120, the row decoder 150, and the input/output circuit 160.

The row decoder 150 may control the plurality of word lines WL based on the control of the control logic circuit 140. For example, the row decoder 150 may activate one of the plurality of word lines WL in response to the control of the control logic circuit 140.

The input/output circuit 160 may receive the data DATA from the memory controller 10, or transmit the data DATA to the memory controller 10.

The input/output circuit 160 may be physically and/or electrically connected to the memory cell array 110 through the plurality of bit lines BL. The input/output circuit 160 may read the data DATA stored in the memory cell array 110 or store the data DATA in the memory cell array 110 by controlling the plurality of bit lines BL.

The in-memory processor 120 may include a plurality of calculation registers CR. The in-memory processor 120 may perform the calculation operation based on the plurality of calculation registers CR. For example, the in-memory processor 120 may perform the calculation operation based on the data stored in the calculation register CR, or store a calculation result generated by performing the calculation operation in the calculation register CR.

In some embodiments, each of one or more operands of the calculation operation performed by the in-memory processor 120 may be data stored in the calculation register CR or data provided from the memory cell array 110 through the input/output circuit 160.

In some embodiments, the in-memory processor 120 may provide the calculation result generated by performing the calculation operation to the memory controller 10 through the input/output circuit 160.

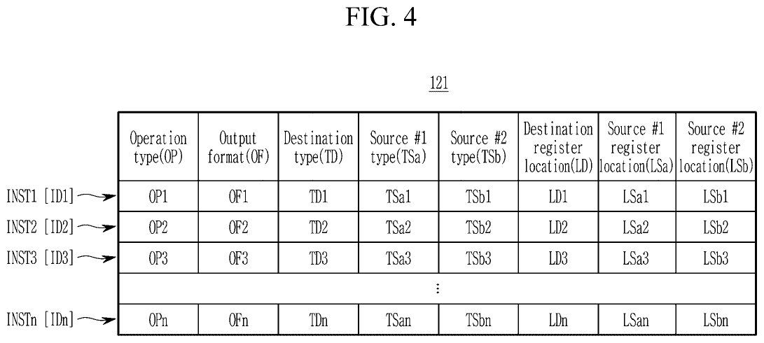

The calculation operation which may be performed by the in-memory processor 120 may be predetermined. For example, the in-memory processor 120 may store a plurality of instructions INST. Each of the plurality of instructions INST may represent a type of calculation to be performed by the in-memory processor 120, a location of the operand, a location to store the calculation result, etc. A configuration of each of the plurality of instructions INST will be described more specifically with reference to FIG. 4.

The control logic circuit 140 may control the operation of the in-memory processor 120 based on the processing command PROC. For example, the control logic circuit 140 may provide an execution request REQ_EXE representing one of the plurality of instructions INST to the in-memory processor 120 in response to the processing command PROC. In this case, the in-memory processor 120 may execute the instruction INST indicated by the execution request REQ_EXE.

A number of instructions INST stored in the in-memory processor 120 may be limited. For example, the number of instructions INST stored in the in-memory processor 120 may be determined based on a width of a channel of the command/address signal C/A transmitted between the memory controller 10 and the memory device 100. In other words, the number of instructions INST which may be executed by the in-memory processor 120 may not be large enough. As a result, the number of calculation operations of the in-memory processor 120 which may be indicated by the memory controller 10 may be limited. For example, the memory controller 10 may request execution of only one of the plurality of instructions INST stored in the in-memory processor 120, and it is difficult to the memory controller to instruct the in-memory processor 120 to perform arbitrary calculation operation based on arbitrary calculation register CR (e.g., any combination of calculation operation and calculation register CR).

In some embodiments, the control logic circuit 140 may provide an address ADDR corresponding to the processing command PROC to the in-memory processor 120. Some of the plurality of instructions INST may indicate one or more of the location of the operand and the location to store the calculation result based on the address ADDR. For example, some of the plurality of instructions INST may indicate one or more of the calculation register storing the operand and the calculation register to store the calculation result, based on an address ADDR corresponding to the processing command PROC. That is, some of the plurality of instructions INST may represent the calculation register CR to be used for executing the instruction INST based on the address ADDR. In this case, the in-memory processor 120 may execute the instruction INST based on the calculation register CR determined by the address ADDR. Accordingly, the memory controller 10 may control a detailed operation of the in-memory processor 120 based on the address ADDR. For example, based on the address ADDR, the memory controller 10 may instruct on which calculation register CR the in-memory processor 120 is to execute the instruction INST based. Accordingly, according to embodiments of the present disclosure, since the memory controller 10 may more freely control the in-memory processor 120, operating efficiency of the memory system MS may be enhanced.

In some embodiments, the in-memory processor 120 may store a plurality of register indexing rules (hereinafter, referred to as “RIR”) for the plurality of instructions INST. The in-memory processor 120 may identify the calculation register CR to be used for executing the instruction INST based on the plurality of register indexing rules RIR and the address ADDR.

In some embodiments, the memory controller 10 may change one or more of the plurality of register indexing rules RIR corresponding to the plurality of instructions INST. In this case, the calculation register CR used for executing the instruction INST may be identified based on the changed register indexing rule. That is, the memory controller 10 may change the calculation register CR to be used for executing the corresponding instruction INST by changing a register indexing rule RIR corresponding to a specific instruction INST. Accordingly, according to embodiments of the present disclosure, since the memory controller 10 may more freely control the in-memory processor 120, the operating efficiency of the memory system MS may be enhanced.

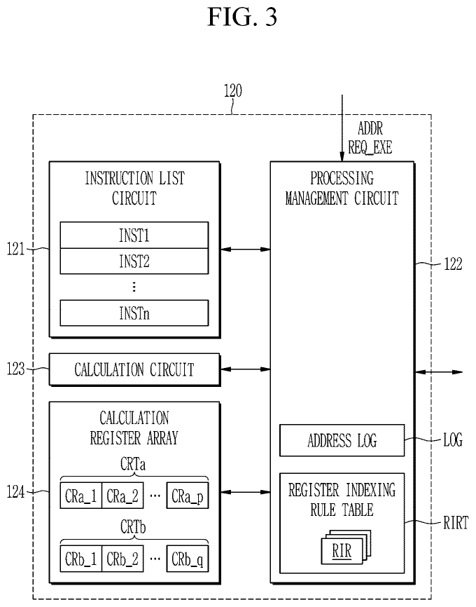

FIG. 3 is a block drawing more specifically illustrating an in-memory processor of FIG. 2. Referring to FIGS. 1 to 3, the in-memory processor 120 may include an instruction list circuit 121, a processing management circuit 122, a calculation circuit 123, and a calculation register array 124.

The instruction list circuit 121 may include a plurality of instructions INST. For example, the instruction list circuit 121 may include first to n-th instructions INST1 to INSTn. The first to n-th instructions INST1 to INSTn may correspond to different combinations of the type of calculation to be performed by the in-memory processor 120, the location of the operand, and the location to store the calculation result, respectively. A configuration of the first to n-th instructions INST1 to INSTn will be described more specifically with reference to FIG. 4 below.

In some embodiments, the first to n-th instructions INST1 to INSTn may be identified based on different instruction identifiers (hereinafter, will be referred to as “ID”) each other. For example, the first to n-th instructions INST1 to INSTn may correspond to first to n-th instruction identifiers, respectively.

The processing management circuit 122 may control overall operations of the in-memory processor 120. For example, the processing management circuit 122 may communicate with the instruction list circuit 121, the calculation circuit 123, and the calculation register array 124.

The calculation circuit 123 may perform the calculation operation. For example, the calculation circuit 123 may perform various types of calculation operations based on one or more operands provided from the calculation register array 124 and the input/output circuit 160 illustrated in FIG. 2.

The calculation register array 124 may include a plurality of calculation registers CR. For example, the calculation register array 124 may include a plurality of calculation registers CRa_1 to CRa_p having a first calculation register type CRTa and a plurality of calculation registers CRb_1 to CRb_q having a second calculation register type CRTb. Hereinafter, for brief description, some embodiments in which a plurality of calculation registers CR included in the calculation register array 124 are classified into two types will be representatively described. However, the scope of the present disclosure is not limited to the number of calculation register types CRT of the calculation registers CR included in the calculation register array 124.

In some embodiments, a plurality of calculation registers having the same calculation register type may be identified based on different register indexes. For example, the plurality of calculation registers CRa_1 to CRa_p may correspond to register indexes ‘1’ to ‘p’, respectively; and the plurality of calculation registers CRb_1 to CRb_q may correspond to register indexes ‘1’ to ‘q’, respectively. That is, each of the plurality of calculation registers CR may be able to be identified from each other based on the calculation register type and the register index. A detailed method in which each of the plurality of calculation registers CR are identified will be described more specifically with reference to the following drawings.

In some embodiments, each of the plurality of calculation registers CRa_1 to CRa_p having the first calculation register type CRTa may be a register for storing scalar data, and the plurality of calculation registers CRb_1 to CRb_q having the second calculation register type CRTb may be registers for storing vector data. For example, a capacity of each of the plurality of calculation registers CRa_1 to CRa_p may be 32 bits, and a capacity of each of the plurality of calculation registers CRb_1 to CRb_q may be an integer multiple of 32 bits. However, the scope of the present disclosure is not limited thereto.

Each of the plurality of calculation registers CR may store an operand or a calculation result for the calculation operation to be performed by the calculation circuit 123.

The processing management circuit 122 may receive the execution request REQ_EXE from the control logic circuit 140. The execution request REQ_EXE may represent one of the first to n-th instructions INST1 to INSTn. For example, the execution request REQ_EXE may include an instruction identifier ID of one of the first to n-th instructions INST1 to INSTn.

The processing management circuit 122 may execute one instruction INST in response to the execution request REQ_EXE. For example, the processing management circuit 122 may execute the instruction INST corresponding to the instruction identifier ID included in the execution request REQ_EXE. In this case, the processing management circuit 122 may control the calculation circuit 123 and the calculation register array 124 to perform an operation indicated by the instruction INST corresponding to the execution request REQ_EXE. For example, the processing management circuit 122 may provide the operand stored in the input/output circuit 160 and/or the calculation register array 124 to the calculation circuit 123, or store the calculation result generated from the calculation circuit 123 in the calculation register array 124.

Meanwhile, one or more of the first to n-th instructions INST1 to INSTn may represent the location of the operand and/or the location to store the calculation result based on the address ADDR. When executing one of such instructions INST, the processing management circuit 122 may identify the location of the operand and/or the location to store the calculation result based on the address ADDR provided from the control logic circuit 140.

More specifically, the processing management circuit 122 may manage an address log LOG. The processing management circuit 122 may receive the address ADDR from the control logic circuit 140. For example, the processing management circuit 122 may receive the address ADDR corresponding to the processing command PROC from the control logic circuit 140. The processing management circuit 122 may store the received address ADDR in the address log LOG.

The processing management circuit 122 may manage a register indexing rule table RIRT. The register indexing rule table RIRT may include a plurality of register indexing rules RIR. The processing management circuit 122 may identify the location of the operand and/or the location to store the calculation result corresponding to the instruction INST to be executed, by converting the address ADDR stored in the address log LOG by using one of the plurality of register indexing rules RIR. A specific method in which the processing management circuit 122 identifies ‘the location of the operand’ and/or ‘the location to store the calculation result’ based on the address log LOG and the register indexing rule table RIRT will be described more specifically with reference to the following drawings.

In some embodiments, the processing management circuit 122 may communicate with the input/output circuit 160 in response to the control of the control logic circuit 140. For example, the processing management circuit 122 may store the operand provided from the input/output circuit 160 in one of the plurality of calculation registers CR, or provide the operand to the calculation circuit 123. As another example, the processing management circuit 122 may provide the calculation result generated by the calculation circuit 123 to the memory controller 10 through the input/output circuit 160.

FIG. 4 is a table more specifically illustrating a configuration of an instruction list circuit of FIG. 3. Referring to FIGS. 1 to 4, the instruction list circuit 121 may include first to n-th instructions INST1 to INSTn.

Hereinafter, for brief description, it is assumed that each of the first to n-th instructions INST1 to INSTn indicate to generate one calculation result by performing a calculation operation with two operands. In this case, the in-memory processor 120 may generate the calculation result by performing calculation with a first operand and a second operand, based on one instruction INST. In this case, a location where the first operand is stored will be referred to as the first source (source #1), a location where the second operand is stored will be referred to as the second source (source #2), and a location where the calculation result to be stored will be referred to as the destination. However, the scope of the present disclosure is not limited thereto.

The first to n-th instructions INST1 to INSTn may be identified based on first to n-th instruction identifiers ID1 to IDn, respectively. For example, when the execution request REQ_EXE includes a first instruction identifier ID1, the processing management circuit 122 may execute the first instruction INST1.

Each of the first to n-th instructions INST1 to INSTn may include an operation type field OP, an output format field OF, a destination type field TD, a first source type field TSa, a second source type field TSb, a destination register location field LD, a first source register location field LSa, and a second source register location field LSb.

Hereinafter, for brief description, the operation type field OP, the output format field OF, the destination type field TD, the first source type field TSa, the second source type field TSb, the destination register location field LD, the first source register location field LSa, and the second source register location field LSb included in an (i)-th instruction INSTi are referred to as an operation type field OPi, the output format field OFi, a destination type field TDi, a first source type field TSai, a second source type field TSbi, a destination register location field LDi, a first source register location field LSai, and a second source register location field LSbi, respectively. For example, the first instruction INST1 may include an operation type field OP1, an output format field OF1, a destination type field TD1, a first source type field TSa1, a second source type field TSb1, a destination register location field LD1, a first source register location field LSa1, and a second source register location field LSb1.

Each of the operation type fields OP1 to OPn may represent the type of in-memory processing calculation. For example, each of the operation type fields OP1 to OPn may represent one of various types of operations such as add, multiplication, multiplication and accumulation (MAC), etc. However, the scope of the present disclosure is not limited to a specific type of in-memory processing operation represented by the operation type field OP.

Each of the output format fields OF1 to OFn may represent a data type of the calculation result. For example, each of the output format fields OF1 to OFn may represent one of various types of data types including FP32, FP16, INT8, etc. As a more detailed example, when the output format field OF1 represents the FP32 data type, the calculation circuit 123 may generate a calculation result having the FP32 data type by executing the first instruction INST1. However, the scope of the present disclosure is not limited to specific data type represented by the output format field OF.

Each of the destination type fields TD1 to TDn may represent a type of a memory space where the calculation result is to be stored. For example, each of the destination type fields TD1 to TDn may represent one of various memory space types including a first calculation register type CRTa, a second calculation register type CRTb, the memory cell array 110, etc. As a more detailed example, when the destination type field TD1 represents the first calculation register type CRTa, the processing management circuit 122 may execute the first instruction INST1, and store the generated calculation result in one of the plurality of calculation registers CRa_1 to CRa_p; when the destination type field TD1 represents the second calculation register type CRTb, the processing management circuit 122 may execute the first instruction INST1, and store the generated calculation result in one of the plurality of calculation registers CRb_1 to CRb_q; and when the destination type field TD1 represents the memory cell array 110, the processing management circuit 122 may execute the first instruction INST1, and store the generated calculation result in the memory cell array 110.

Each of the first source type fields TSa1 to TSan may represent the type of memory space storing the first operand. For example, each of the first source type fields TSa1 to TSan may represent one of various memory space types including such as the first calculation register type CRTa, the second calculation register type CRTb, the memory cell array 110, etc. As a more detailed example, when the first source type field TSa1 represents the first calculation register type CRTa, the processing management circuit 122 may read a first operand for executing the first instruction INST1 from one of the plurality of calculation registers CRa_1 to CRa_p, and provide the first operand to the calculation circuit 123; when the first source type field TSa1 represents the second calculation register type CRTb, the processing management circuit 122 may read a second operand for executing the first instruction INST1 from one of the plurality of calculation registers CRb_1 to CRb_q, and provide the second operand to the calculation circuit 123; and when the first source type field TSa1 represents the memory cell array 110, the processing management circuit 122 may read the first operand for executing the first instruction INST1 from the memory cell array 110, and provide the first operand to the calculation circuit 123.

Similarly, each of the second source type fields TSb1 to TSbn may represent the type of memory space storing the second operand. For example, each of the second source type fields TSb1 to TSbn may represent one of various memory space types including the first calculation register type CRTa, the second calculation register type CRTb, the memory cell array 110, etc.

Hereinafter, for brief description, when the destination type field TD represents any calculation register type (e.g., the first calculation register type CRTa or the second calculation register type CRTb), a calculation register used for storing the calculation result may be referred to as the destination register or as the destination calculation register. Similarly, when the first source type field TSa represents any calculation register type (e.g., the first calculation register type CRTa or the second calculation register type CRTb), a calculation register storing the first operand may be referred to as the first source register or the first source calculation register. Similarly, when the second source type field TSb represents any calculation register type (e.g., the first calculation register type CRTa or the second calculation register type CRTb), a calculation register storing the second operand may be referred to as the second source register or the second source calculation register. Further, a calculation register used for the calculation operation performed by the in-memory processor 120 may be referred to as a target calculation register. For example, each of the destination register, the first source register, and the second source register may be referred to as the target calculation register.

Each of the destination register location fields LD1 to LDn may more specifically represent the location of the destination register. That is, each of the destination register location fields LD1 to LDn may represent which calculation register, among the calculation registers having the calculation register types represented by the corresponding destination type fields TD, will be used to store the calculation result. For example, each of the destination register location fields LD1 to LDn may represent one register index. A more detailed example, when the destination type field TD1 represents the first calculation register type CRTa, the destination register location field LD1 may represent which calculation register is the destination register among the plurality of calculation registers CRa_1 to CRa_p, based on one of register indexes ‘1’ to ‘p’.

In some embodiments, when the destination type field TD represents the memory cell array 110, the destination register location field LD corresponding thereto may not be used. However, the scope of the present disclosure is not limited thereto.

Each of the first source register location fields LSa1 to LSan may more specifically represent a location of a first source register. That is, each of the first source register location fields LSa1 to LSan may represent which calculation register, among the calculation registers having the calculation register types represented by the corresponding first source type field TSa, to store the first operand. For example, each of the first source register location fields LSa1 to LSan may represent one register index. As a more detailed example, when the first source register location field LSa1 represents the second calculation register type CRTb, the destination register location field LD1 may represent which calculation register is the first source register among the plurality of calculation registers CRb_1 to CRb_q, based on one of the register indexes ‘1’ to ‘q’.

In some embodiments, when the first source type field TSa represents the memory cell array 110, the first source register location field LSa corresponding thereto may not be used. However, the scope of the present disclosure is not limited thereto.

Similarly thereto, each of the second source register location fields LSb1 to LSbn may more specifically represent the calculation register storing the second operand. For example, similarly to the description of the first source register location fields LSa1 to LSan, each of the second source register location fields LSb1 to LSbn may represent a second source register based on one register index.

In some embodiments, when the second source type field TSb represents the memory cell array 110, the second source register location field LSb corresponding thereto may not be used. However, the scope of the present disclosure is not limited thereto.

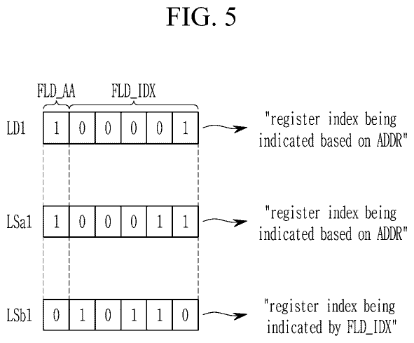

FIG. 5 is a drawing more specifically illustrating a some configuration of an instruction of FIG. 4. Hereinafter, referring to FIGS. 1 to 5, the configuration of the first instruction INST1 will be representatively described. However, the scope of the present disclosure is not limited thereto, and second to n-th instructions INST2˜INSTn may also be able to be implemented by a similar scheme thereto.

The first instruction INST1 may include the destination register location field LD1, the first source register location field LSa1, and the second source register location field LSb1. Each of the destination register location field LD1, the first source register location field LSa1, and the second source register location field LSb1 may include an address align field FLD_AA and a register indexing field FLD_IDX.

The address align field FLD_AA of each of the destination register location field LD1, the first source register location field LSa1, and the second source register location field LSb1 may represent whether to identify the corresponding calculation register based on the address align scheme. For example, the address align field FLD_AA of each of the destination register location field LD1, the first source register location field LSa1, and the second source register location field LSb1 may represent that to represent the register index based on the address ADDR or to represent the register index by the register indexing field FLD_IDX. Hereinafter, a specific scheme in which register index values represented by the destination register location field LD1, the first source register location field LSa1, and the second source register location field LSb1 are determined according to a value of the address align field FLD_AA will be described.

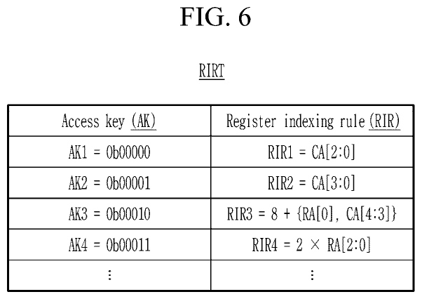

When the address align field FLD_AA of the destination register location field LD1 is ‘1’, the processing management circuit 122 may determine a destination register based on the address ADDR. For example, the processing management circuit 122 may identify one of the plurality of register indexing rules RIR stored in the register indexing rule table RIRT based on the value of the register indexing field FLD_IDX of the destination register location field LD1, and calculate or determine one register index by assigning the address ADDR stored in the address log LOG into the identified register indexing rule RIR. In this case, the processing management circuit 122 may store the calculation result in the calculation register corresponding to the calculated register index. As a more detailed example, the destination type field TD may represent the first calculation register type CRTa, and the value of the register indexing field FLD_IDX of the destination register location field LD1 may be ‘0b00001’. In this case, the processing management circuit 122 may identify the register indexing rule RIR corresponding to ‘0b00001’ among the plurality of register indexing rules RIR stored in the register indexing rule table RIRT, and or determine register index ‘(i)’ (wherein, i represents any integer) by assigning the address ADDR stored in the address log LOG into the identified register indexing rule RIR. In this case, the processing management circuit 122 may determine a calculation register CRa_i as the destination register, and store the calculation result in the calculation register CRa_i. A scheme of determining one of the plurality of register indexing rules RIR stored in the register indexing rule table RIRT based on the register indexing field FLD_IDX, and a scheme of calculation the register index based on the identified register indexing rule RIR and the address log LOG will be described more specifically with reference to FIGS. 6 to 10 below.

Similarly, when the address align field FLD_AA of the first source register location field LSa1 is ‘1’, the processing management circuit 122 may determine the first source register based on the address ADDR. For example, the first source type field TSa1 may represent a second calculation register type CRTb, and a value of the register indexing field FLD_IDX. In this case, the processing management circuit 122 may identify the register indexing rule RIR corresponding to ‘0b00011’ among the plurality of register indexing rules RIR stored in the register indexing rule table RIRT, and calculate or determine register index ‘(j)’ (wherein, j represents any integer) by assigning the address ADDR stored in the address log LOG into the identified register indexing rule RIR.

In this case, the processing management circuit 122 may determine a calculation register CRb_j as the first source register, and fetch the first operand from the calculation register CRb_j.

On the contrary, when the address align field FLD_AA of the second source register location field LSb1 is ‘0’, the processing management circuit 122 may determine the second source register regardless of the address ADDR. For example, the processing management circuit 122 may determine the value of the register indexing field FLD_IDX of the second source register location field LSb1 as a register index represented by the second source register location field LSb1. In this case, the processing management circuit 122 may fetch the second operand from the calculation register corresponding to the register indexing field FLD_IDX of the second source register location field LSb1. As a more detailed example, when the second source type field TSb1 represents the first calculation register type CRTa, and the value of the register indexing field FLD_IDX of the second source register location field LSb1 is ‘0b10110’, the processing management circuit 122 may read the second operand from a calculation register CRa_0b10110.

In some embodiments, a code length of the register indexing field FLD_IDX may be too short to represent each of the plurality of calculation registers CR included in the calculation register array 124. For example, a power of 2 for the code length of the register indexing field FLD_IDX as base may be smaller than ‘p’ or ‘q’. As a result, when the address align field FLD_AA is ‘0’, it may be difficult to represent some of the plurality of calculation registers CR only with (for example, without using the address ADDR) the register location field (e.g., one of the destination register location field LD, the first source register location field LSa, and the second source register location field LSb). On the contrary, according to the embodiments of the present disclosure, the register location field may be able to represent each of the plurality of calculation registers CR based on the address ADDR.

FIG. 6 is a drawing more specifically illustrating a register indexing rule table of FIG. 3. Referring to FIGS. 1 to 6, the register indexing rule table RIRT may include a plurality of register indexing rules RIR. For example, the register indexing rule table RIRT may include first, second, third, and fourth register indexing rules RIR1, RIR2, RIR3, and RIR4. However, the scope of the present disclosure is not limited to the number of register indexing rules included in the register indexing rule table RIRT.

Each of the first, second, third, and fourth register indexing rules RIR1, RIR2, RIR3, and RIR4 may represent different rules (e.g., formulas) for the address ADDR stored in the address log LOG. For example, a first register indexing rule RIR1 may represent a concatenation of second to 0-th bits (i.e., CA[2:0]) of a column address CA stored in the address log LOG; a second register indexing rule RIR2 may represent a concatenation of third to 0-th bits (i.e., CA[3:0]) of the column address CA stored in the address log LOG; a third register indexing rule RIR3 may represent a value acquired by multiplying a concatenation of 0-th bit (i.e., RA[0]) of the row address RA and fourth to third bits (i.e., CA[4:3]) of the column address CA stored in the address log LOG by ‘2’, and then adding ‘8’; and a fourth register indexing rule RIR4 may represent a value acquired by multiplying a concatenation of second to 0-th bits (i.e., CA[2:0]) of the row address RA stored in the address log LOG by ‘2’. However, the scope of the present disclosure will be not limited to a specific configuration of the register indexing rule RIR.

Further, for brief description, hereinafter, some embodiments in which each of the plurality of register indexing rules RIR is defined based on the row address RA and the column address CA will be representatively described. However, the scope of the present disclosure is not limited thereto. For example, some of the plurality of register indexing rules RIR may also be defined based on various types of addresses including a stack identifier, a bank address, etc.

Each of the plurality of register indexing rules RIR may correspond to different access keys AK. For example, the first, second, third, and fourth register indexing rules RIR1, RIR2, RIR3, and RIR4 may correspond to first, second, third, and fourth access keys AK1, AK2, AK3, and AK4, respectively.

The first, second, third, and fourth access keys AK1, AK2, AK3, and AK4 may correspond to different values (e.g., binary codes), respectively. For example, the first, second, third, and fourth access keys AK1, AK2, AK3, and AK4 may correspond to ‘0b00000’, ‘0b00001’, ‘0b00010’, and ‘0b00011’, respectively.

The processing management circuit 122 may select one of the plurality of register indexing rules RIR based on the plurality of access keys AK. More specifically, when the address align field FLD_AA of the first source register location field LSa1 is ‘1’, the processing management circuit 122 may identify the access key AK corresponding to the register indexing field FLD_IDX of the first source register location field LSa1. For example, when the value of the register indexing field FLD_IDX of the first source register location field LSa1 is ‘0b00011’, the processing management circuit 122 may select a fourth register indexing rule RIR4 corresponding to a fourth access key AK4.

The processing management circuit 122 may calculate or determine the register index based on the address ADDR stored in the address log LOG according to the selected register indexing rule RIR. For example, the processing management circuit 122 may calculate or determine the register index by assigning the address ADDR stored in the address log LOG into the fourth register indexing rule RIR4.

The processing management circuit 122 may determine a calculation register to be used for an in-memory processing operation based on the calculated register index. For example, when the first source type field TSa1 represents the first calculation register type CRTa, and the first source register location field LSa1 represents register index ‘(i)’, the processing management circuit 122 may read the first operand from the calculation register CRa_i.

By such scheme, the processing management circuit 122 may identify the first source register, the second source register, and the destination register based on the address AD.

In some embodiments, the processing management circuit 122 may manage one register indexing rule table RIRT. In this case, the processing management circuit 122 may identify all of the first source register, the second source register, and the destination register based on one register indexing rule table RIRT.

According to the embodiments of the present disclosure, the calculation register used for executing one instruction INST may vary depending on the address ADDR stored in the address log LOG. In this case, one instruction INST may represent a plurality of calculation operations for different combinations of a plurality of data stored in the plurality of calculation registers CR. Accordingly, according to the embodiments of the present disclosure, since the number of calculation operations which may be indicated by the memory controller 10 may increase, the degree of freedom of the in-memory processing operation controlled by the memory controller 10 may be enhanced.

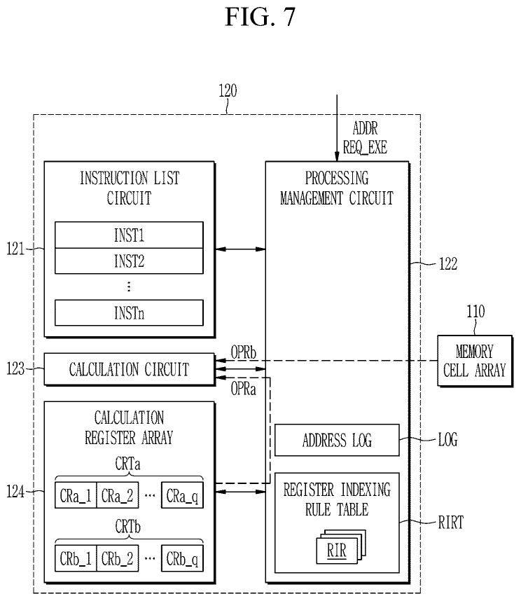

The address ADDR stored in the address log LOG will be described more specifically with reference to FIGS. 7 to 10 below.

FIG. 7 is a drawing more specifically illustrating the operation of the in-memory processor according to some embodiments. Referring to FIGS. 1 to 7, the in-memory processor 120 may perform an in-memory processing operation based on a first operand OPRa stored in the calculation register array 124 and a second operand OPRb stored in the memory cell array 110. That is, the calculation circuit 123 may perform a calculation operation for the first operand OPRa provided from the calculation register array 124 and the second operand OPRb provided from the memory cell array 110.

As a more detailed example, the processing management circuit 122 may receive an execution request REQ_EXE representing a first instruction INST1 from the control logic circuit 140. For example, the processing management circuit 122 may receive the execution request REQ_EXE including a first instruction identifier ID1. The processing management circuit 122 may execute the first instruction INST1 in response to the execution request REQ_EXE. Hereinafter, for brief description, some embodiments in which the processing management circuit 122 executes the first instruction INST1 will be representatively described.

The first instruction INST1 may include a first source type field TSa1 and a second source type field TSb1. The first source type field TSa1 may represent a second calculation register type CRTb. The second source type field TSb1 may represent the memory cell array 110. That is, hereinafter, for brief description, some embodiments in which the first source type field TSa1 represents the second calculation register type CRTb will be representatively described. However, the scope of the present disclosure is not limited thereto. For example, the first source type field TSa1 may also represent a first calculation register type CRTa.

The first instruction INST1 may include a first source register location field LSa1 and a second source register location field LSb1.

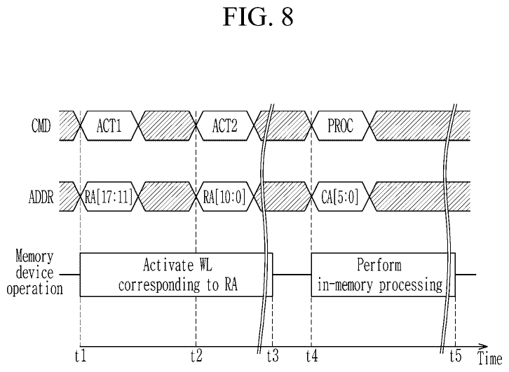

The first source register location field LSa1 may represent one register index. For example, when the address align field FLD_AA of the first source register location field LSa1 is ‘0’, the first source register location field LSa1 may represent the register indexing field FLD_IDX of the first source register location field LSa1 as the register index; when the address align field FLD_AA of the first source register location field LSa1 is ‘1’, the first source register location field LSa1 may represent, as the register index, a result obtained by assigning the address ADDR included in the address log LOG into a register indexing rule RIR determined based on the value of the register indexing field FLD_IDX of the first source register location field LSa1. In this case, the processing management circuit 122 may fetch the first operand OPRa from a calculation register corresponding to the register index represented by the first source register location field LSa1 among the calculation registers CRb_1 to CRb_q having the second calculation register type CRTb, and provide the first operand OPRa to the calculation circuit 123. For example, when the register index represented by the first source register location field LSa1 is ‘j’, the processing management circuit 122 may provide data (i.e., the first operand OPRa) stored in a calculation register CRb_j to the calculation circuit 123. The address ADDR stored in the address log LOG will be described more specifically with reference to FIG. 8 below.

As the second source type field TSb1 represents the memory cell array 110, the second source register location field LSb1 may not be used. That is, regardless of the second source register location field LSb1, the processing management circuit 122 may receive the second operand OPRb from the memory cell array 110, and provide the second operand OPRb to the calculation circuit 123. A specific scheme of providing the second operand OPRb from the memory cell array 110 will be described more specifically with reference to FIG. 8 below.

The first instruction INST1 may include an operation type field OP1. The processing management circuit 122 may notify a calculation type represented by the operation type field OP1 to the calculation circuit 123. For example, the processing management circuit 122 may instruct the calculation circuit 123 to perform one of various operation types including add, multiplication, MAC, etc.

The first instruction INST1 may include an output format field OF1. The processing management circuit 122 may notify a data type represented by the output format field OF1 to the calculation circuit 123. For example, the processing management circuit 122 may instruct the calculation circuit 123 to generate a calculation result corresponding to one of various data types including FP32, FP16, INT8, etc.

The calculation circuit 123 may receive the first operand OPRa and the second operand OPRb. The calculation circuit 123 may perform calculation for the first operand OPRa and the second operand OPRb based on the calculation type instructed by the processing management circuit 122. For example, the calculation circuit 123 may generate a calculation result by multiplying the first operand OPRa and the second operand OPRb. The calculation circuit 123 may provide the calculation result to the processing management circuit 122.

The first instruction INST1 may include a destination type field TD1. The destination type field TD1 may represent a first calculation register type CRTa. That is, hereinafter, for brief description, some embodiments in which the destination type field TD1 represents the first calculation register type CRTa will be representatively described. However, the scope of the present disclosure is not limited thereto. For example, the destination type field TD1 may represent a second calculation register type CRTb.

The first instruction INST1 may include a destination register location field LD1. The destination register location field LD1 may represent one register index. For example, similarly to the description of the first source register location field LD1, the destination register location field LD1 may represent one register index based on the address align field FLD_AA and the register indexing field FLD_IDX of the destination register location field LD1. In this case, the processing management circuit 122 may store the calculation result in the calculation register corresponding to the register index represented by the destination register location field LD1 among the calculation registers CRa_1 to CRa_p. For example, when the register index represented by the destination register location field LD1 is ‘i’, the processing management circuit 122 may provide the calculation result to the calculation register CRa_i.

In some embodiments, the processing management circuit 122 may output the calculation result stored in the calculation register CRa_i to the memory controller 10 through the input/output circuit 160 in response to a read command for the calculation register CRa_i issued form the memory controller 10.

FIG. 8 is a timing diagram more specifically illustrating the operation of the memory device according to the embodiments of FIG. 7. Referring to FIGS. 1 to 8, the memory device 100 may perform an in-memory processing operation based on a first operand OPRa stored in the calculation register array 124 and a second operand OPRb stored in the memory cell array 110.

The memory controller 10 may provide the row address RA and the column address CA in the memory cell array 110 storing the second operand OPRb to the memory device 100 based on one or more activation commands ACT and processing commands PROC.

More specifically, the memory controller 10 may provide a first activation command ACT1 to the memory device 100 at a first time point t1. The memory controller 10 may provide a second activation command ACT2 to the memory device 100 at a second time point t2. The memory controller 10 may provide the processing command PROC to the memory device 100 at a fourth time point t4.

Each of the first activation command ACT1 and the second activation command ACT2 may include some of the row addresses RA in the memory cell array 110 storing the second operand OPRb. For example, the first activation command ACT1 may include 17-th to 11-th bits (i.e., RA[17:11]) of the row address RA in the memory cell array 110 where the second operand OPRb stored. The second activation command ACT2 may include 10-th to 0-th bits (i.e., RA[10:0]) of the row address RA in the memory cell array 110 where the second operand OPRb stored.

The control logic circuit 140 may provide the row address RA included in the first activation command ACT1 and the second activation command ACT2 to the processing management circuit 122. The processing management circuit 122 may store the row address RA in the address log LOG. For example, the processing management circuit 122 may store 17-th to 0-th bits (i.e., RA[17:0]) of the row address RA in the address log LOG.

The memory device 100 may activate word lines WL corresponding to the row addresses RA represented by the first activation command ACT1 and the second activation command ACT2 in response to the first activation command ACT1 and the second activation command ACT2. In this case, at a third time point t3 between the second time point t2 and the fourth time point t4, data stored in memory cells connected to the activated word line WL will be able to be stored in the input/output circuit 160 (e.g., a sense amplifier).

The processing command PROC may include the column address CA in the memory cell array 110 storing the second operand OPRb. For example, the processing command PROC may include 5-th to 0-th bits (i.e., CA[5:0]) of the column address CA in the memory cell array 110 where the second operand OPRb is stored.

The control logic circuit 140 may provide the column address CA included in the processing command PROC to the processing management circuit 122. The processing management circuit 122 may store the column address CA in the address log LOG. For example, the processing management circuit 122 may store 5-th to 0-th bits (i.e., CA[5:0]) of the column address CA in the address log LOG.

The processing command PROC may include a first instruction identifier ID1 corresponding to the first instruction INST1.

The memory device 100 may perform the in-memory processing operation in response to the processing command PROC. For example, the memory device 100 may perform the in-memory processing operation between the fourth time point t4 and a fifth time point t5.

That is, the control logic circuit 140 may provide an execution request REQ_EXE including a first instruction identifier ID1 to the processing management circuit 122. The control logic circuit 140 may provide the second operand OPRb from the input/output circuit 160 to the processing management circuit 122, by controlling the input/output circuit 160 based on the column address CA.

The processing management circuit 122 may receive the second operand OPRb from the input/output circuit 160. Meanwhile, the processing management circuit 122 may read the first operand OPRa from the calculation register array 124 in response to the execution request REQ_EXE. The processing management circuit 122 may provide the first operand OPRa and the second operand OPRb to the calculation circuit 123. The calculation circuit 123 may store a calculation result generated by performing the calculation operation based on the first operand OPRa and the second operand OPRb in the calculation register array 124.

In some embodiments, the processing management circuit 122 may identify a calculation register storing the first operand OPRa based on the address log LOG. For example, when a first source register location field LSa1 of the instruction INST corresponding to the instruction identifier ID included in the execution request

REQ_EXE includes the address align field FLD_AA representing ‘1’, the processing management circuit 122 may provide, to the calculation circuit 123, the first operand OPRa stored in the first source register identified based on the address log LOG and the register indexing rule table RIRT.

In some embodiments, the memory device 100 may output the calculation result stored in the calculation register array 124 to the memory controller 10 in response to a read command (not illustrated) provided from the memory controller 10.

In some embodiments, the address stored in the address log LOG may be initialized after the in-memory processing operation is completed. For example, the address ADDR stored in the address log LOG may be deleted (e.g., invalidated) after the fifth time point t5.

In some embodiments, the control logic circuit 140 may provide the row address RA to the processing management circuit 122 whenever the first activation command ACT1 and the second activation command ACT2 are received. In this case, the processing management circuit 122 may update the address log LOG based on the received row address RA. For example, the processing management circuit 122 may overwrite a new received row address RA to the address log LOG. In this case, the row address RA and the column address CA stored in the address log LOG may correspond to the processing command PROC. For example, the address log LOG may be able to include the row address RA included in the activation commands ACT corresponding to the processing command PROC, and the column address CA included in the processing command PROC. In other words, the address log LOG may be able to include the column address CA included in the processing command PROC, and the row address RA included in the activation commands ACT issued immediately before the processing command PROC.

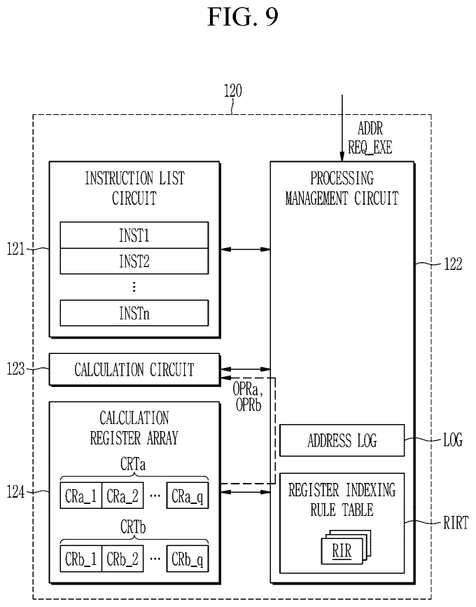

FIG. 9 is a drawing more specifically illustrating the operation of the in-memory processor according to some embodiments. Referring to FIGS. 1 to 6, and FIG. 9, the in-memory processor 120 may perform the in-memory processing operation based on the first operand OPRa and the second operand OPRb both stored in the calculation register array 124. That is, the calculation circuit 123 may perform the calculation operations for the first operand OPRa and the second operand OPRb both provided from the calculation register array 124.

As a more detailed example, the processing management circuit 122 may receive an execution request REQ_EXE representing the second instruction INST2 from the control logic circuit 140. For example, the processing management circuit 122 may receive the execution request REQ_EXE including a second instruction identifier ID2. The processing management circuit 122 may execute the second instruction INST2 in response to the execution request REQ_EXE. Hereinafter, for brief description, some embodiments in which the processing management circuit 122 executes the second instruction INST2 will be representatively described.

The second instruction INST2 may include a first source type field TSa2 and a second source type field TSb2. The first source type field TSa2 and the second source type field TSb2 may represent the first calculation register type CRTa. That is, hereinafter, for brief description, some embodiments in which both of the first source type field TSa2 and the second source type field TSb2 represent the first calculation register type CRTa will be representatively described. However, the scope of the present disclosure is not limited thereto. For example, one or more of the first source type field TSa2 and the second source type field TSb2 may represent the second calculation register type CRTb.

The second instruction INST2 may include a first source register location field LSa2 and a second source register location field LSb2. The first source register location field LSa2 and the second source register location field LSb2 may represent the register indexes for the first and second source registers, respectively. For example, each of the first source register location field LSa2 and the second source register location field LSb2 may represent one register index based on an address align field FLD_AA and a register indexing field FLD_IDX corresponding thereto. In this case, the processing management circuit 122 may receive the first operand OPRa from the first source register determined based on the first source type field TSa2 and the first source register location field LSa2. The processing management circuit 122 may receive the second operand OPRb from the second source register determined based on the second source type field TSb2 and the second source register location field LSb2. A scheme of determining one calculation register based on the first source type field TSa2 and the first source register location field LSa2, and a scheme of determining one calculation register based on the second source type field TSb2 and the second source register location field LSb2 are similar to the schemes described with reference to FIGS. 1 to 8 above, so a detailed description is omitted.

The calculation circuit 123 may receive the first operand OPRa and the second operand OPRb. The calculation circuit 123 may perform calculation for the first operand OPRa and the second operand OPRb based on the calculation type instructed by the processing management circuit 122. The calculation circuit 123 may provide the calculation result to the processing management circuit 122. The processing management circuit 122 may store the calculation result in a calculation register determined based on a destination type field TD2 and a destination register location field LD2.

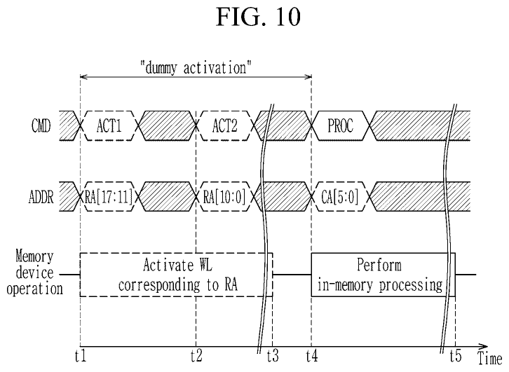

FIG. 10 is a timing diagram more specifically illustrating the operation of the memory device according to the embodiments of FIG. 9. Referring to FIGS. 1 to 6, and FIGS. 9 to 10, the memory device 100 may perform the in-memory processing operation based on the first operand OPRa and the second operand OPRb stored in the calculation register array 124. Hereinafter, a difference from the embodiments described above with reference to FIG. 8 will be primarily described.

The memory controller 10 may issue the processing command PROC at the fourth time point t4. The processing command PROC may include the second instruction identifier ID2. The memory device 100 may execute the second instruction INST2. That is, the memory device 100 may perform the in-memory processing operation for the first operand OPRa and the second operand OPRb stored in the calculation register array 124. That is, the memory device 100 may perform the in-memory processing operation regardless of data stored in the memory cell array 110.

Therefore, the memory controller 10 may not issue (e.g., omit to issue) the first and second activation commands ACT1 and ACT2 at the first time point t1 and the second time point t2, respectively. That is, although the memory controller 10 issues only the processing command PROC, the memory device 100 may perform the in-memory processing operation based on the first operand OPRa and the second operand OPRb. As a more detailed example, when the address align field FLD_AA of each of the first source register location field LSa2 and the second source register location field LSb2 is ‘0’, the memory device 100 may perform the in-memory processing operation regardless of the row address RA. In such a context, the memory device 100 will also be able to perform the in-memory processing operation regardless of the column address CA included in the processing command PROC.

However, the scope of the present disclosure is not limited thereto, the memory controller 10 may issue the first and second activation commands ACT1 and ACT2 prior to the fourth time point t4. In this case, the memory device 100 may perform a dummy activation operation prior to the fourth time point t4. For example, the memory device 100 may activate the word lines corresponding to the row addresses RA included in the first and second activation commands ACT1 and ACT2. The processing management circuit 122 may store the row addresses RA included in the first and second activation commands ACT1 and ACT2 in the address log LOG. Further, the processing management circuit 122 may store the column address CA included in the processing command PROC in the address log LOG. In this case, the processing management circuit 122 may perform the in-memory processing operation based on the address stored in the address log LOG. For example, when the address align field FLD_AA of one or more of ‘the destination register location field LD2, the first source register location field LSa2, and the second source register location field LSb2’ is ‘1’, the memory device 100 will be able to perform the in-memory processing operation based on the address stored in the address log LOG.

That is, according to the embodiments of the present disclosure, when the instruction INST corresponding to the processing command PROC may be executed regardless of the address ADDR, the memory controller 10 may not issue the activation command ACT prior to the processing command PROC, and the memory device 100 may perform the in-memory processing operation regardless of the activation command ACT issued from the memory controller 10. However, when the instruction INST corresponding to the processing command PROC is executed based on the address ADDR, the memory controller 10 may also issue the activation command ACT prior to the processing command PROC. In this case, the row address RA included in the activation command ACT and/or the column address CA included in the processing command PROC may be used for identifying the calculation register (e.g., the destination register, the first source register, or the second source register) to be used for the in-memory processing operation.

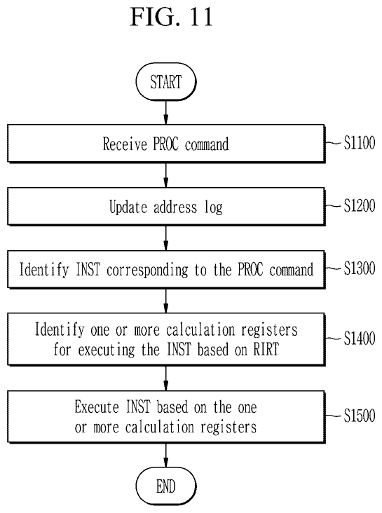

FIG. 11 is a flowchart illustrating the operation of the memory device according to the embodiments of the present disclosure. Referring to FIGS. 1 to 11, in step S1100, a memory device 100 may receive a processing command PROC.

In step S1200, the memory device 100 may update an address log LOG. For example, the memory device 100 may store row address RA included in activation commands ACT corresponding to the processing command PROC, and column address CA included in the processing command PROC in the address log LOG.

In step S1300, the memory device 100 may identify an instruction INST corresponding to the processing command PROC. For example, a control logic circuit 140 may provide an execution request REQ_EXE including an instruction identifier ID included in the processing command PROC to a processing management circuit 122. The processing management circuit 122 may identify one instruction INST corresponding to the instruction identifier ID from an instruction list circuit 121.

For brief description, in FIG. 11, some embodiments in which step S1200 is performed between step S1100 and step S1300 is representatively described, but the scope of the present disclosure is not limited thereto. For example, the memory device 100 may store the row address RA in the address log LOG before step S1100 is performed, or perform step S1200 after step S1300 is performed. That is, the scope of the present disclosure is not limited to a specific sequence of performing step S1200.

In step S1400, the memory device 100 may identify one or more calculation registers CR for executing the instruction INST based on a register indexing rule table RIRT. For example, the processing management circuit 122 may identify a calculation register CR (e.g., a destination register) to store a calculation result based on a destination type field TD and a destination register location field LD included in the instruction INST identified in step S1300 above, may identify a calculation register CR (e.g., a first source register) storing a first operand OPRa based on a first source type field TSa and a first source register location field LSa, and may identify a calculation register CR (e.g., a second source register) storing a second operand OPRb based on a second source type field TSb and a second source register location field LSb.

In step S1500, the memory device 100 may execute the instruction INST based on one or more calculation registers CR. For example, the calculation circuit 123 may perform a calculation operation based on the operands OPR stored in the first and second source registers identified in step S1400 above, or store the calculation result in the destination register.

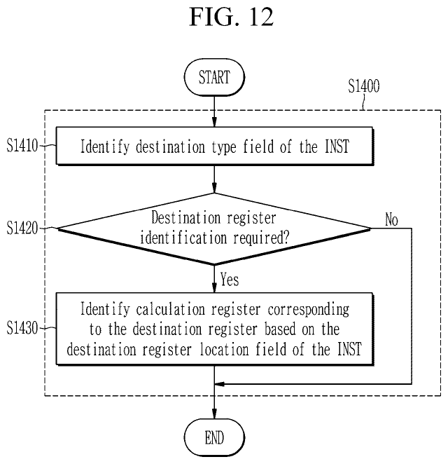

FIG. 12 is a drawing more specifically illustrating step S1400 of FIG. 11. Referring to FIGS. 1 to 12, step S1400 may include steps S1410 to S1430 discussed below. For brief description, hereinafter, an operation of the processing management circuit 122 identifying the calculation register CR to store the calculation result based on the destination type field TD and the destination register location field LD will be representatively described. However, the scope of the present disclosure is not limited thereto, but in a similar scheme thereto, the processing management circuit 122 may identify the calculation register CR storing the first operand OPRa based on the first source type field TSa and the first source register location field LSa, and identify the calculation register CR storing the second operand OPRb based on the second source type field TSb and the second source register location field LSb.

In step S1410, the processing management circuit 122 may identify the destination type field TD of the instruction INST.

In step S1420, the processing management circuit 122 may determine whether the destination register needs to be identified. For example, when the destination type field TD of the instruction INST represents one of the first and second calculation register types CRTa and CRTb, the processing management circuit 122 may determine that the destination register needs to be identified. In contrast, when the destination type field TD of the instruction INST represents the memory cell array 110, the processing management circuit 122 may determine that there is no need to identify the destination register.

In step S1420, when it is determined that the destination register needs to be identified, step S1430 below may be performed.

In step S1420, when it is determined that there is no need to identify the destination register, step S1400 may be terminated.

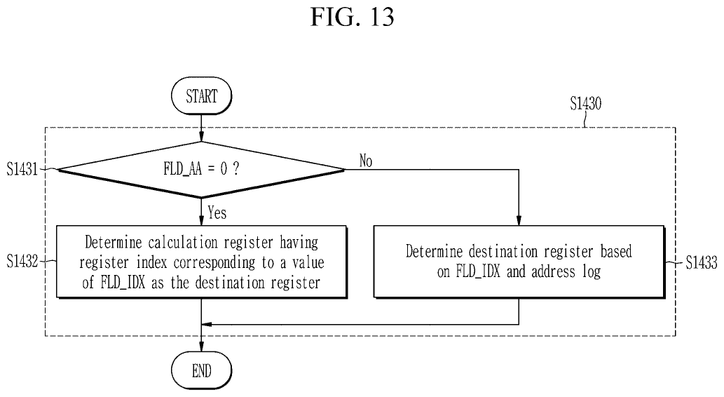

In step S1430, the processing management circuit 122 may identify a calculation register corresponding to the destination register based on the destination register location field LD of the instruction INST. Step S1430 is described more specifically with reference to FIG. 13 below.

FIG. 13 is a drawing more specifically illustrating step S1430 of FIG. 12. Referring to FIGS. 1 to 13, step S1430 may include steps S1431 to S1433 below.

In step S1431, the processing management circuit 122 may determine whether the address align field FLD_AA is ‘0’. For example, the processing management circuit 122 may determine whether the address align field FLD_AA included in the destination register location field LD is ‘0’. When the address align field FLD_AA is ‘0’, step S1432 below may be performed. When the address align field FLD_AA is not ‘0’ (e.g., ‘1’), step S1433 below may be performed.

In step S1432, the processing management circuit 122 may determine a calculation register CR having a register index corresponding to a value of a register indexing field FLD_IDX as the destination register. For example, when the register indexing field FLD_IDX included in the destination register location field LD is ‘k’, the processing management circuit 122 may determine a calculation register corresponding to register index ‘k’ among calculation registers of a calculation register type represented by the destination type field TD as the destination register.

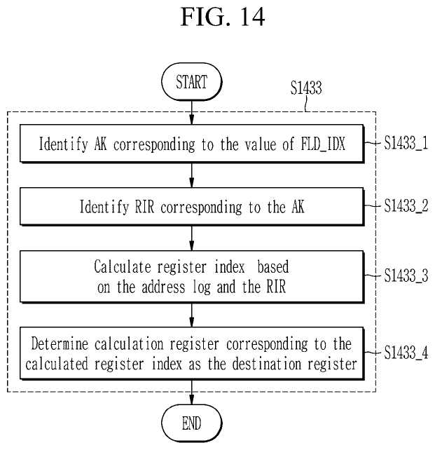

In step S1433, the processing management circuit 122 may determine the destination register based on the register indexing field FLD_IDX and the address log LOG. Step S1433 is described more specifically with reference to FIG. 14 below.

FIG. 14 is a drawing more specifically illustrating step S1433 of FIG. 13. Referring to FIGS. 1 to 14, step S1433 may include steps S1433_1 to S1433_4 below.

In step S1433_1, the processing management circuit 122 may identify an access key AK corresponding to the value of the register indexing field FLD_IDX. For example, the processing management circuit 122 may identify an access key AK having the same value as the register indexing field FLD_IDX.

In step S1433_2, the processing management circuit 122 may identify a register indexing rule RIR corresponding to the access key AK. For example, the processing management circuit 122 may identify the register indexing rule RIR corresponding to the access key AK identified in step S1433_1.

In step S1433_3, the processing management circuit 122 may calculate or determine the register index based on the address log LOG and the register indexing rule RIR. For example, the processing management circuit 122 may calculate or determine the register index by assigning the row address RA and/or the column address CA included in the address log LOG into the register indexing rule RIR identified in step S1433_2.

In step S1433_4, the processing management circuit 122 may determine the calculation register corresponding to the calculated register index as the destination register. For example, when the register index calculated in step S1433_3 is ‘k’, the processing management circuit 122 may determine the calculation register having the register index of ‘k’ among the calculation registers of the calculation register type represented by the destination type field TD as the destination register.

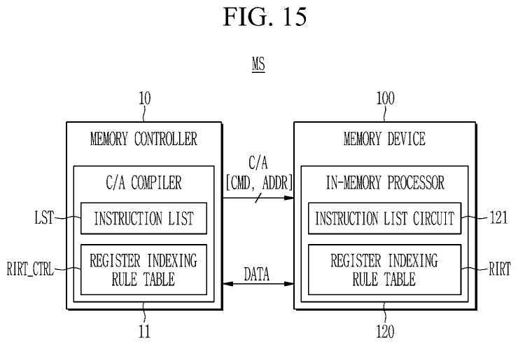

FIG. 15 is a block diagram illustrating a memory system according to some embodiments. Referring to FIGS. 1 to 15, the memory system MS may include a memory controller 10 and a memory device 100.

The memory device 100 may include an in-memory processor 120. The in-memory processor 120 may include an instruction list circuit 121 and a register indexing rule table RIRT. A configuration and an operation of the memory device 100 are similar to those described with reference to FIGS. 1 to 14 above, so a detailed description is omitted.

The memory controller 10 may include a command/address compiler 11. The command/address compiler 11 may manage an instruction list LST and a register indexing rule table RIRT_CTRL.

The instruction list LST may include the first to n-th instructions INST1 to INSTn described with reference to FIG. 4 above. The register indexing rule table RIRT_CTRL may include the plurality of register indexing rules RIR described with reference to FIG. 6 above. That is, the instruction list LST may be synchronized with the instruction list managed by the instruction list circuit 121, and the register indexing rule table RIRT_CTRL may be synchronized with the register indexing rule table RIRT.

Accordingly, the memory controller 10 may manage a plurality of instructions INST used in the memory device 100 based on the instruction list LST, and manage a plurality of register indexing rules RIR used in the memory device 100 based on the register indexing rule table RIRT_CTRL.

The command/address compiler 11 may identify a calculation operation requested from an application (e.g., an artificial intelligence model, etc.) driven by the memory system MS. The command/address compiler 11 may issue command/address signals (C/A) corresponding to the required calculation operation based on the instruction list LST and the register indexing rule table RIRT_CTRL. For example, the command/address compiler 11 may issue a processing command PROC including an instruction identifier ID for a required instruction INST based on the instruction list LST. Further, when the instruction INST required for the calculation operation requested from the application represents one or more of the destination register, the first source register, and/or the second source register based on the address log LOG, the command/address compiler 11 may issue the processing command PROC and activation commands ACT corresponding thereto so that an appropriate address ADDR may be stored in the address log LOG based on the register indexing rule table RIRT_CTRL.

However, it may be difficult to instruct all calculation operations requested from the application for driving the memory system MS only with the register indexing rule table RIRT. For example, it may be difficult to represent a combination of the calculation registers required for the calculation operation requested from the application only with the plurality of register indexing rules RIR included in the register indexing rule table RIRT, or it may be difficult to represent an address ADDR storing data required for the calculation operation requested from the application. That is, there may be a situation in which it is difficult that the command/address compiler 11 compiles the command/address signal (C/A) representing the calculation operation requested from the application due to a limit in the number of instructions stored in the instruction list circuit 121 and a limit in the number of register indexing rules stored in the register indexing rule table RIRT. In this case, the memory controller 10 may change the plurality of instructions INST stored in the instruction list circuit 121, or may change the register indexing rule table RIRT, and then instruct the calculation operation to the memory device 100.

In some embodiments, a total capacity of the plurality of instructions INST stored in the instruction list circuit 121 may be relatively large. For example, the total capacity of the plurality of instructions INST stored in the instruction list circuit 121 may be dozens of bytes (or more). That is, the plurality of instructions INST may have too large a capacity to be stored in one register. As a result, when the memory controller 10 is configured to update all of the plurality of instructions INST stored in the instruction list circuit 121, a large latency may occur according to a time required for the memory controller 10 to transmit the plurality of instructions INST to the memory device 100 and a time required to store the plurality of instructions INST in the instruction list circuit 121. In this case, an operating speed of the memory system MS may be deteriorated.

In some embodiments, the memory controller 10 may be configured to update one of the plurality of instructions INST stored in the instruction list circuit 121. In this case, whenever there is the situation in which it is difficult to compile the command/address signal (C/A), the memory controller 10 may provide one instruction INST to the memory device 100. In this case, as the memory device 100 repeatedly performs a read operation and a write operation, the operating speed of the memory device 100 may be significantly deteriorated.

In some embodiments, the memory controller 10 may be configured to update the register indexing rule table RIRT. For example, the memory controller 10 provides the register indexing rule table RIRT to the memory device 100 to update the register indexing rule table RIRT. However, in this case, a large latency may occur according to a time required for the memory controller 10 to transmit the plurality of register indexing rules RIR to the memory device 100 and a time required to store the plurality of register indexing rules RIR in the processing management circuit 122. In this case, the operating speed of the memory system MS may be deteriorated.

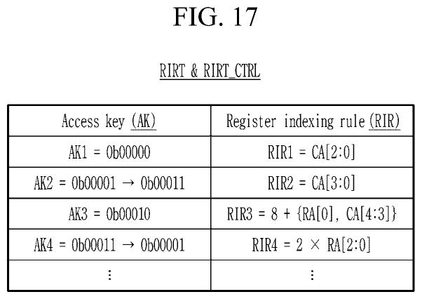

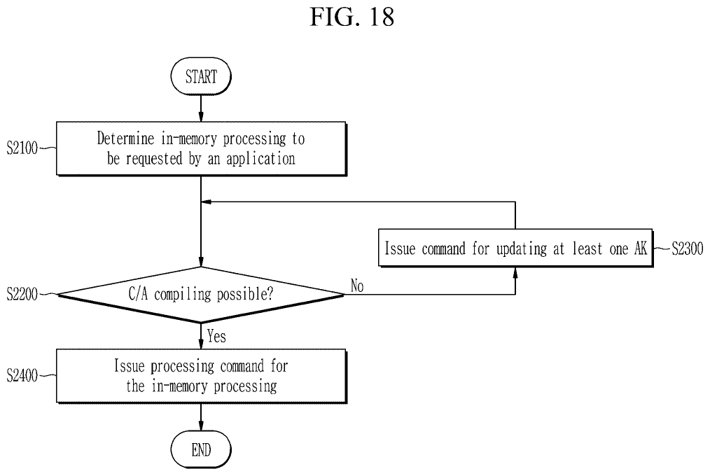

The command/address compiler 11 according to the embodiments of the present disclosure may appropriately change some of a plurality of access keys AK included in the register indexing rule table RIRT. In this case, the register indexing rule RIR for identifying the calculation register used for executing the instruction INST may be changed. Accordingly, the command/address compiler 11 may appropriately instruct all calculation operations requested from the application by changing some of the plurality of access keys AK. A scheme in which the command/address compiler 11 changes some of the plurality of access keys AK will be described more specifically with reference to FIGS. 17 and 18 below.

In some embodiments, the command/address compiler 11 may update some of the plurality of access keys AK by issuing a register write command. For example, when each of the plurality of access keys AK are allocated to different mode registers, the command/address compiler 11 may be able to change an access key stored in one mode register by issuing a mode register write command. However, the scope of the present disclosure is not limited thereto.

That is, the command/address compiler 11 may update only some of the plurality of access keys AK instead of updating the register indexing rule RIR or updating the plurality of instructions INST. For example, the command/address compiler 11 may be able to instruct the required calculation operation after providing only one or more access keys AK to the memory device 100 instead of newly providing the plurality of register indexing rules RIR or the plurality of instructions INST to the memory device 100. In this case, since a frequency at which the plurality of register indexing rules RIR are updated and a frequency at which the plurality of instructions INST are updated may be minimized, the performance of the memory system MS will be able to be enhanced.

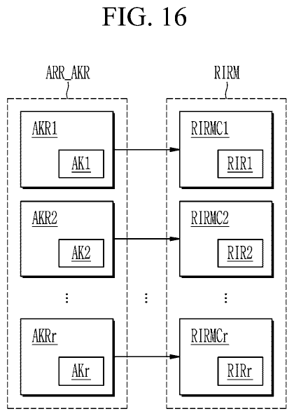

FIG. 16 is a block diagram illustrating a some configuration of a processing management circuit of FIG. 3 according to the embodiments of FIG. 15. Referring to FIGS. 1 to 16, the processing management circuit 122 may include an access key register array ARR_AKR and a register indexing rule memory RIRM.

The access key register array ARR_AKR may include first to r-th access key registers AKR1 to AKRr. The first to r-th access key registers AKR1 to AKRr may store first to r-th access keys AK1 to AKr, respectively.

The register indexing rule memory RIRM may include first to r-th register indexing rule memory circuits RIRMC1 to RIRMCr. The first to r-th register indexing rule memory circuits RIRMC1 to RIRMCr may store first to r-th register indexing rules RIR1 to RIRr, respectively.

Each of the first to r-th access keys AK1 to AKr may be used for selecting one of the first to r-th register indexing rules RIR1 to RIRr based on the value of the register indexing field FLD_IDX. A scheme of using the first to r-th access keys AK1 to AKr is described with reference to FIG. 6 above, so a detailed description is omitted.

The first to r-th access key registers AKR1 to AKRr may correspond to the first to r-th register indexing rule memory circuits RIRMC1 to RIRMCr, respectively. For example, the first to r-th access key registers AKR1 to AKRr may be used for accessing the first to r-th register indexing rule memory circuits RIRMC1 to RIRMCr, respectively. As a more detailed example, a first access key register AKR1 may be used for accessing a first register indexing rule RIR1 stored in a first register indexing rule memory circuit RIRMC1, and a second access key register AKR2 may be used for accessing a second register indexing rule RIR2 stored in a second register indexing rule memory circuit RIRMC2.

Accordingly, although a destination register location field LD of a specific instruction INST is determined in advance, a register indexing rule RIR used for identifying the destination register may vary depending on that which register indexing rule memory circuit RIRMC corresponds to an access key AK corresponding thereto. For example, although the register indexing field FLD_IDX of the destination register location field LD of the specific instruction INST represents ‘0b00001’, an access key AK corresponding thereto is changed from a second access key AK2 to a third access key AK3, so a register indexing rule used for identifying the destination register may be changed from the second register indexing rule RIR2 to the third register indexing rule RIR3. In this case, the calculation register instructed by the destination register location field LD of the specific instruction INST may be changed. As a result, the in-memory processor 120 will be able to execute the corresponding instruction INST (i.e., perform another calculation operation) based on the changed calculation register. That is, according to the embodiments of the present disclosure, the memory controller 10 changes the access key AK to change the calculation register CR used for the in-memory processor 120 to execute the specific instruction INST. A specific scheme of changing the access key AK by the memory controller 10 will be described more specifically with reference to FIG. 17 below.

In some embodiments, each of the first to r-th access key registers AKR1 to AKRr may be implemented as a mode register. In this case, the command/address compiler 11 issues a mode register write (MRW) command to change the access key AK stored in one of the first to r-th access key registers AKR1 to AKRr. However, the scope of the present disclosure is not limited thereto.

FIG. 17 is a drawing more specifically illustrating a method of changing an access key by a memory controller of FIG. 15. Hereinafter, a detailed example scheme of changing the access keys AK stored in the register indexing rule table RIRT and RIRT_CTRL will be described with reference to FIGS. 1 to 17.

Referring to FIGS. 1 to 17, the memory controller 10 may change one or more access keys AK. For example, the memory controller 10 may change a value (e.g., a code value) of a second access key AK2 from ‘0b00001’ to ‘0b00011’. In this case, although the register indexing field FLD_IDX of one or more of the register location fields (e.g., the destination register location field LD, the first source register location field LSa, and the second source register location field LSb) of the specific instruction INST represents ‘0b00011’, the processing management circuit 122 may calculate or determine the register index based on the second register indexing rule RIR2.

In contrast, although the register indexing field FLD_IDX of one or more of the register location fields (e.g., the destination register location field LD, the first source register location field LSa, and the second source register location field LSb) of the specific instruction INST represents ‘0b00001’, the processing management circuit 122 may calculate or determine the register index based on another register indexing rule other than the second register indexing rule RIR2. For example, the memory controller 10 may change a fourth access key AK4 from ‘0b00011’ to ‘0b00001’. In this case, the processing management circuit 122 may calculate or determine the register index corresponding to the specific instruction INST based on the second register indexing rule RIR2 other than the fourth register indexing rule RIR4.

In some embodiments, the memory controller 10 may change one access key AK by issuing one register write command. For example, the memory controller 10 may change the second access key AK2 by issuing a first register write command, and change the fourth access key AK4 by issuing a second register write command. However, the scope of the present disclosure is not limited thereto. For example, the memory controller 10 may also change two or more access keys AK by issuing one register command.

In some embodiments, the memory controller 10 may exchange two different access keys AK with each other by issuing two register write commands. For example, the memory controller 10 may exchange codes corresponding to the second access keys AK2 and the fourth access key AK4 with each other by issuing the first and second register write commands. However, the scope of the present disclosure is not limited thereto. For example, when the second access key AK2 is changed to ‘0b00011’, the memory controller 10 may also change the fourth access key AK4 to any code (e.g., ‘0b11111’) instead of the code (e.g., ‘0b00001’) of the existing second access key AK2.

In some embodiments, the memory controller 10 may manage the register indexing rule tables RIRT and RIRT_CTRL so that each of the plurality of access keys AK correspond to different codes. For example, when two or more access keys AK correspond to the same code, the memory controller 10 may change one code (e.g., an earliest changed code) among the access keys AK. As a more detailed example, when both the second access key AK2 and the fourth access key AK4 correspond to ‘0b00011’, the memory controller 10 may change the fourth access key AK4.

FIG. 18 is a flowchart more specifically illustrating an operation of the memory controller of FIG. 15. Referring to FIGS. 1 to 18, the memory controller 10 may determine the in-memory processing operation requested from the application in step S2100.

In step S2200, the memory controller 10 may determine whether command/address compiling is possible. For example, the command/address compiler 11 may determine whether the command/address signal C/A representing the in-memory processing operation determined in step S2100 above can be compiled.

When it is determined that the compiling is not possible in step S2200, step S2300 below may be performed. When it is determined that the compiling is possible in step S2200, step S2400 below may be performed.

In step S2300, the memory controller 10 may issue a command for updating at least one access key AK. For example, the command/address compiler 11 may issue one or more register write command for one or more access key registers AKR. In this case, the in-memory processor 120 may change access keys stored in one or more access key registers AKR in response to the register write command.

In step S2400, the memory controller 10 may issue the processing command PROC for the in-memory processing determined in step S2100 above. For example, the command/address compiler 11 may issue the command/address signal C/A representing the processing command PROC corresponding to the in-memory processing operation determined in step S2100 above.

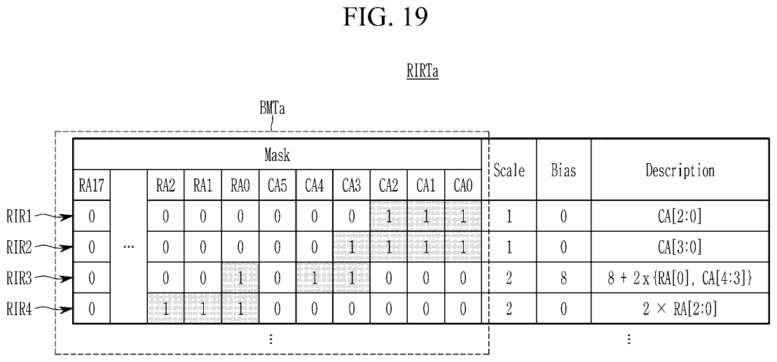

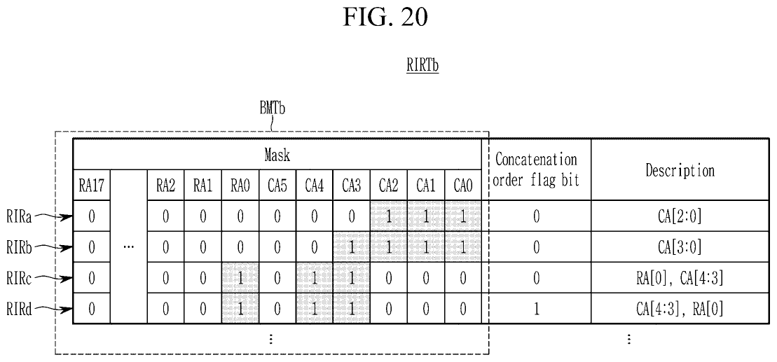

FIGS. 19 to 20 illustrate a method of storing a plurality of register indexing rules in the register indexing rule table of FIG. 3.

First, referring to FIGS. 1 to 19, the register indexing rule table RIRT may be implemented as a register indexing rule table RIRTa. The register indexing rule table RIRTa may include first, second, third, and fourth register indexing rules RIR1, RIR2, RIR3, and RIR4.

The register indexing rule table RIRTa may include a bit masking table BMTa. The bit masking table BMTa may store a masking bit for each of bits of the row address RA and the column address CA provided from the address log LOG. For example, the bit masking table BMTa may include a plurality of masking bits corresponding to 17-th to 0-th bits (e.g., RA[17:0]) of the row address RA and 5-th to 0-th bits (e.g., CA[5:0]) of the column address CA, respectively.

The register indexing rule table RIRTa may represent address bits corresponding to the plurality of register indexing rules RIR, respectively based on the bit masking table BMTa. For example, when address bits required for representing a first register indexing rule RIR1 are second to 0-th bits (e.g., CA[2:0]) of the columns address CA, the bit masking table BMTa may represent masking bits corresponding to the first register indexing rule RIR1 and the second to 0-th bits (e.g., CA[2:0]) of the columns address CA as ‘1’. Similarly, when address bits required for a third register indexing rule RIR3 are a 0-th bit (e.g., RA[0]) of the row address RA and fourth to third bits (e.g., CA[4:3]) of the column address CA, the bit masking table BMTa may represent masking bits corresponding to the third register indexing rule RIR3 and the 0-th bit (e.g., RA[0]) of the row address RA and fourth to third bits (e.g., CA[4:3]) of the column address CA as ‘1’. By such scheme, the bit masking table BMTa may represent address bits used for representing the plurality of register indexing rules RIR, respectively.

In some embodiments, the bit masking table BMTa may represent bits corresponding to an address not required for representing the register indexing rule RIR as ‘0’.

Accordingly, according to the embodiments of the present disclosure, the processing management circuit 122 may calculate or determine the register index based on a result of concatenating the address bits represented by the bit masking table BMTa. For example, when address bits represented for the first register indexing rule RIR1 by the bit masking table BMTa are second to 0-th bits (e.g., CA[2:0]) of the column address CA, the processing management circuit 122 may determine the register index based on a value of concatenating second to 0-th bits of the column address CA stored in the address log LOG. As a more detailed example, when the second to 0-th bits of the column address CA stored in the address log LOG are ‘CA[2]=1’, ‘CA[1]=0’, ‘CA[0]=0’, the processing management circuit 122 may calculate or determine the register index based on ‘0b100’ (e.g., 4).

In some embodiments, bit locations of respective bits when the processing management circuit 122 concatenates the address bits represented by the bit masking table BMTa may be predetermined. For example, when address bits represented for the first register indexing rule RIR1 by the bit masking table BMTa are second to 0-th bits (e.g., CA[2:0]) of the column address CA, the processing management circuit 122 may concatenate second to 0-th bits (e.g., CA[2:0]) of the column address CA in a predetermined order. As a more detailed example, the processing management circuit 122 may concatenate the second bit (e.g., CA[2]) of the column address CA as a most significant bit, concatenate the first bit (e.g., CA[1]) of the column address CA as an intermediate bit, and concatenate the 0-th bit (e.g., CA[0]) of the column address CA as a least significant bit. However, the scope of the present disclosure is not limited thereto.

The register indexing rule table RIRTa may include a plurality of scale values and a plurality of bias values corresponding to the plurality of register indexing rules RIR, respectively. For example, the register indexing rule table RIRTa may store ‘1’ which is a scale value corresponding to the first register indexing rule RIR1, and store ‘2’ which is a scale value corresponding to the third register indexing rule RIR3. The register indexing rule table RIRTa may store ‘0’ which is a bias value corresponding to the first register indexing rule RIR1, and store ‘8’ which is a bias value corresponding to the third register indexing rule RIR3.

The processing management circuit 122 may calculate or determine the register index for each of the plurality of register indexing rules RIR based on the scale value and the bias value according to a result of concatenating the address bits represented by the bit masking table BMTa. For example, the processing management circuit 122 may calculate or determine the register index by multiplying the result of concatenating the address bits represented by the bit masking table BMTa by the corresponding scale value, and then adding the bias value.

As a more detailed example, when the result of concatenating the address bits represented by the bit masking table BMTa for the first register indexing rule RIR1 by the processing management circuit 122 is ‘0b100’ (e.g., 4), the processing management circuit 122 may calculate or determine a register index ‘4’ by multiplying ‘4’ by the scale value ‘1’, and then adding the bias value ‘0’.

Similarly, when the result of concatenating the address bits represented by the bit masking table BMTa for the third register indexing rule RIR3 by the processing management circuit 122 is ‘0b111’ (e.g., 7), the processing management circuit 122 may calculate or determine a register index ‘22’ by multiplying ‘7’ by a scale value ‘2’, and then adding a bias value ‘8’.

Next, referring to FIGS. 1 to 20, the register indexing rule table RIRT may be implemented as a register indexing rule table RIRTb. The register indexing rule table RIRTb may include first, second, third, and fourth register indexing rules RIRa to RIRd.

The register indexing rule table RIRTb may include a bit masking table BMTb. The register indexing rule table RIRTb may represent address bits corresponding to the plurality of register indexing rules RIR, respectively based on the bit masking table BMTb. For example, when address bits required for a third register indexing rule RIRc are a 0-th bit (e.g., RA[0]) of the row address RA and fourth to third bits (e.g., CA[4:3]) of the column address CA, the bit masking table BMTb may represent masking bits corresponding to the third register indexing rule RIRc and the 0-th bit (e.g., RA[0]) of the row address RA and fourth to third bits (e.g., CA[4:3]) of the column address CA as ‘1’. Similarly, the bit masking table BMTb may represent masking bits corresponding to a fourth register indexing rule RIRd, and the 0-th bit (e.g., RA[0]) of the row address RA and fourth to third bits (e.g., CA[4:3]) of the column address CA as ‘1’.

The processing management circuit 122 may calculate or determine the register index based on a result of concatenating the address bits represented by the bit masking table BMTb. A scheme of concatenating the address bits represented by the bit masking table BMTb by the processing management circuit 122 is described with reference to FIG. 19 above, so a detailed description is omitted.

The register indexing rule table RIRTb may include a plurality of concatenation order flag bits corresponding to the plurality of register indexing rules RIR, respectively. For example, the register indexing rule table RIRTb may store ‘0’ which is a concatenation order flag bit corresponding to the third register indexing rule RIRc, and store ‘1’ which is a concatenation order flag bit corresponding to the fourth register indexing rule RIRd.

The processing management circuit 122 may determine bit locations of respective bits when concatenating the address bits represented by the bit masking table BMTb based on the concatenation order flag bit. For example, when the concatenation order flag bit is ‘0’, the processing management circuit 122 may determine bits corresponding to the row address RA as more significant bits than bits corresponding to the column address CA. When the concatenation order flag bit is ‘1’, the processing management circuit 122 may determine the bits corresponding to the columns address CA as more significant bits than bits corresponding to the row address RA.

As a more detailed example, all address bits required for the third register indexing rule RIRc and the fourth register indexing rule RIRd may be the 0-th bit (e.g., RA[0]) of the row address RA and fourth to third bits (e.g., CA[4:3]) of the column address CA. However, the concatenation order flag bit corresponding to the third register indexing rule RIRc may be ‘0’, and the concatenation order flag bit corresponding to the fourth register indexing rule RIRd may be ‘1’. In this case, the processing management circuit 122 may concatenate the 0-th bit (e.g., RA[0]) of the row address RA as a more significant bit, and concatenate the fourth to third bits (e.g., CA[4:3]) of the column address CA as a less significant bit, with respect to the third register indexing rule RIRc. In contrast, the processing management circuit 122 may concatenate the 0-th bit (e.g., RA[0]) of the row address RA as the less significant bit, and concatenate the fourth to third bits (e.g., CA[4:3]) of the column address CA as the more significant bit, with respect to the fourth register indexing rule RIRd.

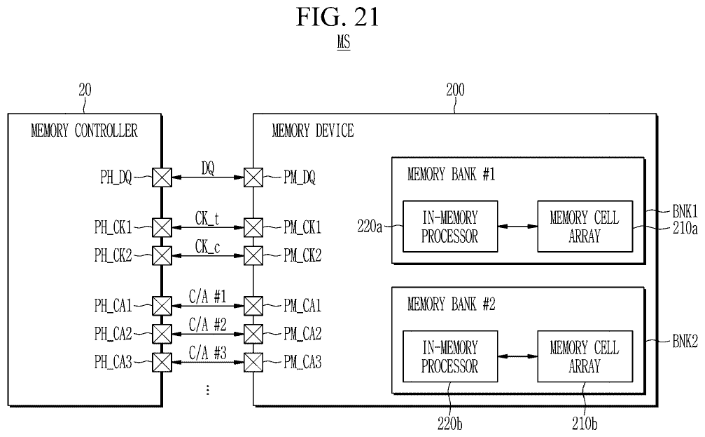

FIG. 21 is a block diagram illustrating a memory system according to some embodiments. Referring to FIGS. 1 to 21, the memory system MS may include a memory controller 20 and a memory device 200. A configuration and an operation of the memory controller 20 are similar to the configuration and the operation of the memory controller 10 described with reference to FIGS. 1 to 20 above, so a detailed description is omitted.

The memory device 200 may include a plurality of memory banks BNK. For example, the memory device 200 may include a first memory bank BNK1 and a second memory bank BNK2.

Each of the first memory bank BNK1 and the second memory bank BNK2 may include an in-memory processor 220 and a memory cell array 210. For example, the first memory bank BNK1 may include a first memory cell array 210a and a first in-memory processor 220a, and the second memory bank BNK2 may include a second memory cell array 210b and a second in-memory processor 220b.

In some embodiments, the first memory cell array 210a and the first in-memory processor 220a may correspond to the memory cell array 110 and the in-memory processor 120 described with reference to FIGS. 1 to 20 above, respectively.

The first in-memory processor 220a and the second in-memory processor 220b may operate independently of each other. For example, the first in-memory processor 220a may perform a calculation operation based on an operand provided from the first memory cell array 210a, or store a calculation result in the first memory cell array 210a. The second in-memory processor 220b may perform a calculation operation based on an operand provided from the second memory cell array 210b, or store the calculation result in the second memory cell array 210b.

The memory controller 20 may include a data pin PH_DQ, a first clock pin PH_CK1, a second clock pin PH_CK2, and a plurality of command/address pins PH_CA.

The memory device 200 may include a data pin PM_DQ, a first clock pin PM_CK1, a second clock pin PM_CK2, and a plurality of command/address pins PM_CA.

The data pin PH_DQ, the first clock pin PH_CK1, the second clock pin PH_CK2, and the plurality of command/address pins PH_CA may be connected to the data pin PM_DQ, the first clock pin PM_CK1, the second clock pin PM_CK2, and the plurality of command/address pins PM_CA, respectively through different channels.

The memory controller 20 may provide a data signal DQ to the memory device 200 through a channel connected to the data pins PH_DQ, or receive the data signal DQ from the memory device 200. In this case, the data signal DQ may carry the data DATA described with reference to FIGS. 1 to 20 above. For a brief description, it is illustrated in FIG. 21 that each of the memory controller 20 and the memory device 200 is connected through one data pin, but the present disclosure is not limited thereto. For example, each of the memory controller 20 and the memory device 200 may include 8 or 16 pins, or 32 data pins.

The memory controller 20 may provide a clock signal CK_t to the memory device 200 through a channel connected to the first clock pin PH_CK1. The memory controller 20 may provide an inverted clock signal CK_c to the memory device 200 through a channel connected to the second clock pin PH_CK2. The clock signal CK_t and the inverted clock signal CK_c may have a complementary phase to each other.

The memory controller 20 may provide a plurality of command/address signals C/A to the memory device 200 through channels connected to a plurality of command/address pins PH_CA. For example, the memory controller 20 may provide a first command/address signal C/A #1 to a first command/address pin PM_CA1 through a first command/address pin PH_CA1, provide a second command/address signal C/A #2 to a second command/address pin PM_CA2 through a second command/address pin PH_CA2, and provide a third command/address signal C/A #3 to a third command/address pin PM_CA3 through a third command/address pin PH_CA3. For a brief description, it is illustrated in FIG. 21 that each of the memory controller 20 and the memory device 200 is connected through three command/address pins, but the present disclosure is not limited thereto. For example, each of the memory controller 20 and the memory device 200 may include 7 or 14 command/address pins.

The memory device 100 may identify the command/addresses signal C/A based on the clock signal CK_t and the inverted clock signal CK_c. For example, the memory device 100 may identify the plurality of command/address signals C/A based on a rising edge or a falling edge of the clock signal CK_t.

The memory controller 20 may integrally control the plurality of in-memory processors 220 based on the plurality of command/address signals C/A. For example, the memory controller 20 may provide the processing command PROC to both the first memory bank BNK1 and the second memory bank BNK2 based on the plurality of command/address signals C/A. In this case, both a first in-memory processor 220a and a second in-memory processor 220b may perform the in-memory processing operation in response to the processing command PROC.

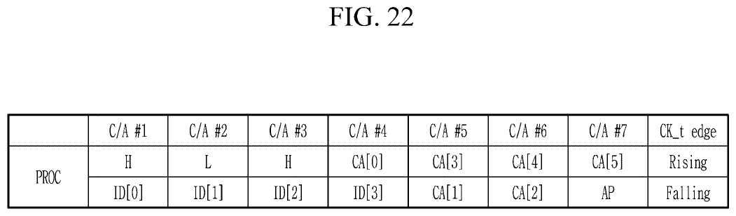

FIG. 22 is a command truth table illustrating a configuration of a processing command implemented according to some embodiments. Hereinafter, for a brief description, a configuration of the processing command PROC defined based on first to seventh command/address signals C/A #1 to C/A #7 will be examples described with reference to FIGS. 1 to 22. However, the scope of the present disclosure is not limited thereto.

The processing command PROC may be defined based on logic levels of the first to seventh command/address signals C/A #1 to C/A #7 at time point when the rising edge and the falling edge of the clock signal CK_t occurs. That is, the memory controller 20 may provide the processing command PROC to the memory device 200 by set the logic levels of the first to seventh command/address signals C/A #1 to C/A #7 at the time point when the rising edge and the falling edge occurs.

The memory device 200 may identify the processing command PROC based on that the first to third command/address signals C/A #1 to C/A #3 are respectively logic high H, logic low L, and logic high H, of the time point when the rising edge of the clock signal CK_t occurs. In this case, the memory device 200 may determine the fourth to seventh command/address signals C/A #4 to C/A #7 at the time point when the rising edge of the clock signal CK_t occurs as a 0-bit (CA[0]), a third bit (CA[3]), a fourth bit (CA[4]), and a fifth bit (CA[5]) of the column address CA, respectively. The memory device 200 may determine the first, second, third, and fourth command/address signals C/A #1 to C/A #4 at the time points when the falling edge of the clock signal CK_t occurs as 0-th to third bits (ID[0:3]) of the instruction identifier ID, respectively. The memory device 200 may determine the fifth and sixth command/address signals C/A #5 and C/A #6 at the time point when the falling edge of the clock signal CK_t occurs as a first bit (CA[1]) and a second bit (CA[2]) of the column address CA, respectively. However, the scope of the present disclosure is not limited thereto.

In some embodiments, the memory device 200 may determine whether to enter an auto-precharge mode based on the seventh command/address signal C/A #7 at the time point when the falling edge of the clock signal CK_t occurs. However, the scope of the present disclosure is not limited thereto.

In some embodiments, the number of instruction identifiers ID which may be represented by the processing command PROC may be determined based on a number of bits for the instruction identifier ID included in the processing command PROC. That is, the number of instruction identifiers ID which may be represented by the processing command PROC may be limited based on a width of a channel in which the plurality of command/address signals C/A are transmitted. However, according to the embodiments of the present disclosure, although the number of instruction identifiers ID which may be represented by the processing command PROC is limited, the number of calculation operations which the in-memory processor 220 may perform based on one instruction INST may increase, so operation efficiency of the memory system MS may be enhanced.

The above-described contents are specific embodiments for carrying the present disclosure. The present disclosure will include not only the above-described embodiments, but also embodiments that can be simply designed or easy to change. In addition, the present disclosure will also include technologies that can be easily modified and implemented using embodiments. Therefore, the scope of the present disclosure should not be limited to the embodiments and should be defined by the appended claims of the present disclosure and equivalents to the appended claims.

What is claimed is:

1. An in-memory processor including a memory device, comprising:
an instruction list circuit configured to store a first instruction including a first register indexing field;
a calculation register array comprising a plurality of calculation registers;
a processing management circuit configured to store a register indexing rule table and an address log, wherein the register indexing rule table comprises a first register indexing rule that corresponds to a value of the first register indexing field, and wherein the processing management circuit is configured to identify a first calculation register of the plurality of calculation registers based on the first register indexing rule and the address log; and
a calculation circuit configured to perform a first calculation operation for the first instruction based on the first calculation register.

2. The in-memory processor of claim 1, wherein the register indexing rule table comprises a plurality of access keys and a plurality of register indexing rules respectively corresponding to the plurality of access keys, and
wherein the processing management circuit is configured to identify a first access key corresponding to the first register indexing field from among the plurality of access keys, and to identify the first calculation register based on the first register indexing rule corresponding to the first access key.

3. The in-memory processor of claim 2, wherein the processing management circuit comprises:
a plurality of register indexing rule memory circuits configured to store the plurality of register indexing rules, respectively; and
a plurality of access key registers respectively corresponding to the plurality of register indexing rule memory circuits, and respectively storing the plurality of access keys.

4. The in-memory processor of claim 3, wherein the processing management circuit is configured to change an access key stored in one of the plurality of access key registers in response to a request from outside the in-memory processor.

5. The in-memory processor of claim 2, wherein the register indexing rule table comprises the plurality of register indexing rules which are based on a bit masking table for at least one of a row address and a column address stored in the address log.

6. The in-memory processor of claim 1, wherein the address log comprises a column address included in a processing command provided to the memory device and indicating the first instruction.

7. The in-memory processor of claim 6, wherein the address log further comprises a row address included in one or more activation commands provided to the memory device prior to the processing command.

8. The in-memory processor of claim 1, wherein a number of the plurality of calculation registers is greater than a power of 2 of a code length of the first register indexing field as base.

9. The in-memory processor of claim 1, wherein the first instruction further comprises a first address align field,
wherein the instruction list circuit is further configured to store a second instruction including a second register indexing field and a second address align field,
wherein the processing management circuit is configured to:
identify the first calculation register based on the first register indexing rule when a value of the first address align field is a first value; and
identify a second calculation register having a register index corresponding to a value of the second register indexing field when a value of the second address align field is a second value, and
wherein the calculation circuit is further configured to perform a second calculation operation for the second instruction based on the second calculation register.

10. The in-memory processor of claim 1, wherein the calculation circuit is configured to store the first calculation result generated by performing the first calculation operation in the first calculation register, or to receive a first operand for the first calculation operation from the first calculation register.

11. An in-memory processor included in a memory device, the in-memory processor comprising:
an instruction list circuit configured to store a first instruction;
a plurality of calculation registers;
a processing management circuit configured to determine a first register index based on a first register indexing rule in response to reception of a first execution request for the first instruction at a first time point, and to determine a second register index based on a second register indexing rule in response to reception of a second execution request for the first instruction at a second time point after the first time point; and
a calculation circuit configured to perform a first calculation operation for the first instruction based on a first calculation register corresponding to the first register index among the plurality of calculation registers, and to perform a second calculation operation for the first instruction based on a second calculation register corresponding to the second register index among the plurality of calculation registers.

12. The in-memory processor of claim 11, wherein the processing management circuit comprises:
a first register indexing rule memory circuit configured to store the first register indexing rule;
a second register indexing rule memory circuit configured to store the second register indexing rule;
a first access key register configured to access the first register indexing rule memory circuit; and
a second access key register configured to access the second register indexing rule memory circuit, and
wherein the first access key register is configured to store a first access key and the second access key register is configured to store a second access key.

13. The in-memory processor of claim 12, wherein the first instruction includes a first register indexing field, and
wherein the processing management circuit is configured to identify an access key register that stores an access key corresponding to a value of the first register indexing field, and to determine a register index based on a register indexing rule stored in a register indexing rule memory circuit corresponding to the identified access key register.

14. The in-memory processor of claim 13, wherein the processing management circuit is configured to change the second access key based on a value of the first access key between the first time point and the second time point.

15. The in-memory processor of claim 14, wherein the processing management circuit is configured to change the value of the second access key to the value of the first access key based on a second register write command for the second access key register provided to the memory device from outside the in-memory processor, between the first time point and the second time point.

16. The in-memory processor of claim 11, wherein the processing management circuit further comprises an address log, and
wherein the processing management circuit is configured to:
determine the first register index further based on a first row address and a first column address stored in the address log at the first time point, and
determine the second register index further based on a second row address and a second column address stored in the address log at the second time point.

17. The in-memory processor of claim 16, wherein the first column address is stored in the address log based on a first processing command, which corresponds to the first execution request, provided to the memory device, and
wherein the second column address is stored in the address log based on a second processing command, which corresponds to the second execution request, provided to the memory device.

18. The in-memory processor of claim 17, wherein the first row address is stored in the address log based on a first activation command provided to the memory device prior to the first processing command, and
wherein the second row address is stored in the address log based on a second activation command provided to the memory device prior to the second processing command.

19. A memory device configured to perform a calculation operation, comprising:
an in-memory processor configured to perform the calculation operation based on a target calculation register of a plurality of calculation registers; and
a control logic circuit configured to change a register indexing rule used to determine the target calculation register in response to a command provided from an external device.

20. The memory device of claim 19, wherein the in-memory processor comprises:
a plurality of register indexing rule memory circuits configured to store a plurality of register indexing rules, respectively; and
a plurality of access key registers respectively corresponding to the plurality of register indexing rule memory circuits, and respectively configured to store a plurality of access keys, and
wherein the control logic circuit is configured to change the register indexing rule used to determine the target calculation register by changing at least one of the plurality of access keys in response to the command from the external device.
